(19) United States
(12) Patent Application Publication
(10) Pub. No.: US 2024/0181406 A1
(43) Pub. Date: Jun. 6, 2024

(54) Device and Method for Mixing Fluids and for Producing a Fluid Mixture

(71) Applicants: FDX Fluid Dynamix GmbH, Berlin (DE); Fraunhofer-Gesellschaft zur Förderung der angewandten Forschung e.V., München (DE)

(72) Inventors: Bernhard Bobusch, Berlin (DE); Jens Hermann Wintering, Berlin (DE); Oliver Krüger, Berlin (DE); Eckart Uhlmann, Berlin (DE); Christoph Hein, Berlin (DE); Gregor Dürre, Berlin (DE); Annika Brehmer, Berlin (DE)

(21) Appl. No.: 18/287,697

(22) PCT Filed: Apr. 21, 2022
(86) PCT No.: PCT/EP2022/060609

§ 371 Date: Oct. 20, 2023

(30) Foreign Application Priority Data
Apr. 21, 2021 (DE) 10 2021 110 094.1

(51) Int. Cl. B01F 25/314; B01F 23/41; B01F 23/451; B01F 101/22

(52) U.S. Cl. CPC B01F 25/314; B01F 23/4105; B01F 23/451; B01F 2101/22

(57) ABSTRACT

The invention relates to a device for mixing fluids and for producing a fluid mixture, including, a mixing chamber having a first inlet opening via which a first fluid can be introduced into the mixing chamber, a second inlet opening via which a second fluid can be introduced into the mixing chamber, and an outlet opening via which the fluid mixture including the first fluid and the second fluid can be discharged; a first supply unit, which is fluidically connected to the mixing chamber via the first inlet opening and is designed to carry the first fluid along a first fluid flow direction into the mixing chamber; and a second supply unit, which is fluidically connected to the mixing chamber via the second inlet opening and is designed to carry the second fluid along a second fluid flow direction into the mixing chamber. The first supply unit includes a fluidic component, including an outlet opening, which is fluidically connected to the first inlet opening of the mixing chamber, and at least one means for specifically changing the direction of the first fluid that flows through the fluidic component, in particular in order to cause an oscillation in space of the fluid at the outlet opening.

### CROSS-REFERENCE TO RELATED APPLICATIONS

This application is the United States national phase of International Application No. PCT/EP2022/060609 filed Apr. 21, 2022, and claims priority to German Patent Application No. 10 2021 110 094.1 filed Apr. 21, 2021, the disclosures of which are hereby incorporated by reference in their entireties.

### BACKGROUND OF THE INVENTION

### Field of the Invention

The disclosure relates to a device for mixing fluids and for producing a fluid mixture, and to a corresponding method. The production of fluid mixtures plays an important role for example in chemistry, microbiology, biochemistry, pharmaceutics, medical technology, and food technology. In this case, it is important that the produced fluid mixture should have defined properties. If, in a mixing process, for example particles (in the nanometer range) occur, then often a specific particle size linked with a defined size distribution is sought. The device according to the solution and the method according to the solution are suitable for producing (nano)particles.

### Description of Related Art

Microfluidic systems are known from the prior art for producing fluid mixtures or (nano)particles which operate in the nanoliter scale and require precise control of temperature, dwell time and concentrations of dissolved substances. These systems comprise flow channels which have a long length with respect to their cross section, such that the flow-related resistance is relatively high. These systems are both expensive and susceptible to blockages. A use of these systems in mass production may also be difficult or even impossible.

### SUMMARY OF THE INVENTION

An object underlying the proposed solution is to provide a device and a method for mixing fluids and for producing a fluid mixture which are less susceptible to faults and are also suitable for the mass production of fluid mixtures or particles having defined properties. In particular, the object also consists in mixing fluids, using the same mixing technology, both at the laboratory scale (i.e. a few nanoliters per minute) and in mass production (i.e. several liters per minute), and in producing a fluid mixture

The produced fluid mixtures can for example be solutions for parenteral nutrition, or medicines for oral or topical application.

This object is achieved by a device having features as described herein.

According thereto, the device for mixing fluids and for producing a fluid mixture firstly comprises a mixing chamber having a first inlet opening via which a first fluid can be introduced into the mixing chamber, a second inlet opening via which a second fluid can be introduced into the mixing chamber, and an outlet opening via which the fluid mixture comprising the first fluid and the second fluid can be discharged. The device further comprises a first supply device, which is fluidically connected to the mixing chamber via the first inlet opening and is configured to carry the first fluid along a first fluid flow direction into the mixing chamber, and a second supply device, which is fluidically connected to the mixing chamber via the second inlet opening and is configured to carry the second fluid along a second fluid flow direction into the mixing chamber.

In this case, the first supply device comprises a fluidic component which has an outlet opening which is fluidically connected to the first inlet opening of the mixing chamber. In particular, the outlet opening of the fluidic component can correspond to the first inlet opening of the mixing chamber.

The fluidic component is characterized by at least one means for specifically changing the direction of the first fluid which flows through the fluidic component. For specifically changing the direction, alternating vortices, i.e. produced by colliding fluid flows within the fluidic component, or by a disruptive body within the fluidic component, can be used. In the case of this type of means for producing the specific change in direction, sufficient space must be provided for the production and the subsequent decay of the vortex structures. In particular, said at least one means for causing an oscillation in space, of the first fluid, is provided and formed at the outlet opening.

The first fluid is thus carried into the mixing chamber not as a (quasi) stationary flow, but rather as an oscillating fluid flow. In addition to a longitudinal flow component, the first fluid also has a lateral flow component, which changes over time. As a result, turbulences can be produced in the mixing chamber, such that a high mixing quality can be achieved in the mixing chamber. The device is thus characterized in that the first fluid enters the mixing chamber, from the first supply device, in an oscillating or dynamic manner. As a result, the first fluid obtains a constantly changing flow speed component, transversely to its main flow direction. In this case, the oscillating first fluid entering the mixing chamber can have a Reynolds number of over 600, approximately 1000, or even over 1000. The oscillation frequency of the oscillating first fluid can be at least 100 Hz, typically over 2000 Hz.

An advantage of the device according to the solution is that the flow resistance is relatively low. Therefore, the device according to the solution can be used for mixing processes for mixing minimal amounts, for example in the microliter range, and also for mixing processes in mass production (for example involving several liters per minute).

According to one embodiment, it is provided that the fluidic component comprises a flow chamber which, in addition to the outlet opening already mentioned also comprises an inlet opening, and through which the first fluid can flow, which fluid enters the flow chamber through the inlet opening, and emerges from the flow chamber through the outlet opening. According to one embodiment, the inlet opening and the outlet opening of the fluidic component can be of different widths. In particular, the flow chamber comprises a main flow channel which interconnects the inlet opening of the flow chamber (or of the fluidic component) and the outlet opening of the flow chamber (or of the fluidic component), and at least one auxiliary flow channel as the means for specifically changing the direction of the first fluid. Movable components for producing the oscillation can be omitted in the device according to the solution, such that costs and expenses resulting therefrom do not arise. Furthermore, due to the omission of movable components, the vibration and noise development is relatively low.

The flow chamber can comprise the above-mentioned at least one auxiliary flow channel, as means for specifically changing the direction of the first fluid. A portion of the first fluid, the auxiliary flow, can flow through the auxiliary flow channel. The portion of the first fluid that does not enter the auxiliary flow channel but rather emerges from the fluidic component is referred to as the main flow. The at least one auxiliary flow channel can comprise an intake, which is located in the vicinity of the outlet opening of the fluidic component, and an output, which is located in the vicinity of the inlet opening of the fluidic component. The at least one auxiliary flow channel can be arranged beside (not behind or in front of) the main flow channel, viewed along the first fluid flow direction (from the inlet opening to the outlet opening). In particular, two auxiliary flow channels can be provided which (viewed along the first fluid flow direction) extend laterally beside the main flow channel, wherein the main flow channel is arranged between the two auxiliary flow channels. According to a preferred embodiment, the auxiliary flow channels and the main flow channel are arranged in a row, transversely to the first fluid flow direction, and extend in each case along the first fluid flow direction.

Preferably, the at least one auxiliary flow channel is separated from the main flow channel by a block. This block can be of different shapes. For example, the cross section of the block can taper, viewed along the first fluid flow direction (from the inlet opening to the outlet opening). Furthermore, the block can comprise rounded edges.

Sharp edges can be provided on the block in particular in the vicinity of the inlet opening and/or of the outlet opening.

According to one embodiment, the at least one auxiliary flow channel can be of a greater or smaller depth than the main flow channel. (In this case, the depth is the extension transversely to the oscillation plane of the first fluid.) It is thereby possible to influence the oscillation frequency of the first fluid emerging from the fluidic component.

As a result of a reduction in the component depth in the region of the at least one auxiliary flow channel (compared with the main flow channel), the oscillation frequency reduces, if the remaining parameters remain largely unchanged. Correspondingly, the oscillation frequency increases if the component depth in the region of the at least one auxiliary flow channel is increased (compared with the main flow channel), and the remaining parameters remain largely unchanged.

A further possibility for influencing the oscillation frequency of the first fluid emerging from the fluidic component can be provided by at least one separator, which is preferably provided at the intake of the at least one auxiliary flow channel. The separator assists the separation of the auxiliary flow from the flow of the first fluid. In this case, a separator is to be understood as an element that protrudes into the flow chamber at the intake of the at least one auxiliary flow channel (transversely to the flow direction prevailing in the auxiliary flow channel). The separator can be provided as a deformation (in particular an indentation) of the auxiliary flow channel wall, or as a projection formed in another manner. For example, the separator can be configured in the shape of a (circular) cone or a pyramid. The use of a separator of this kind makes it possible, in addition to influencing the oscillation frequency, to also vary what is known as the oscillation angle. The oscillation angle is the angle over which the oscillating fluid jet sweeps (between its two maximum deflections). If a plurality of auxiliary flow channels is provided, then a separator can be provided for each of the auxiliary flow channels, or just for some of the auxiliary flow channels.

The cross-sectional area of the individual inlet and outlet openings of the device can be of any shape, for example square, rectangular, polygonal, circular, oval, etc.

According to one embodiment, the first supply device and the first inlet opening of the mixing chamber on the one hand, and the second supply device and the second inlet opening of the mixing chamber on the other hand, are arranged relative to one another in such a way that the first fluid flow direction and the second fluid flow direction enclose an angle of 0° to 90°. Said angle is preferably in a range of 35° to 55°. An angle of substantially 45° is particularly preferred. As a result, the mixing quality and the mixing path length or the mixing duration can be positively influenced. For reasons of manufacturing technology, the angle can also be substantially 90°.

If the means for specifically changing the direction of the first fluid is configured to bring about an oscillation of the first fluid in an oscillation plane, then the second supply device and the second inlet opening of the mixing chamber can be arranged in such a way that the second fluid flow direction and the oscillation plane of the first fluid enclose an angle, in a plane transverse to the first fluid flow direction, of 30° to 150°. Said angle is preferably substantially 90°.

The mixing chamber can comprise a longitudinal axis which is defined such that it extends along the first fluid flow direction. According to one embodiment, it is provided that the cross-sectional area of the mixing chamber, transversely to the longitudinal axis, changes along the longitudinal axis. For example, the cross-sectional area can become larger and/or smaller over the course of the longitudinal axis of the mixing chamber. In this case, the size development of the cross-sectional area can be configured such that the formation of what are known as wake spaces in the mixing chamber can be prevented. For example, the cross-sectional area can increase, proceeding from the first inlet opening of the mixing chamber in an upstream end portion of the mixing chamber, with increasing distance from the first inlet opening, and/or reduce in a downstream end portion of the mixing chamber, with increasing distance from the first inlet opening. The upstream end portion can thus form an inlet channel of the mixing chamber (that widens in the downstream direction), and the downstream end portion can form an outlet channel (that tapers in the downstream direction). In this case, the outlet channel can directly adjoin the inlet channel.

Alternatively, an intermediate portion of the mixing chamber can be provided between the inlet channel and the outlet channel, in which intermediate portion the cross-sectional area of the mixing chamber is substantially constant.

If the means for specifically changing the direction of the first fluid is configured to bring about an oscillation of the first fluid in an oscillation plane, the extension of the mixing chamber in the oscillation plane and transversely to the longitudinal axis, proceeding from the first inlet opening of the mixing chamber, in the inlet channel, can increase with increasing distance from the first inlet opening, or the extension of the mixing chamber in the oscillation plane and transversely to the longitudinal axis in the outlet channel can decrease with increasing distance from the first inlet opening. In the inlet channel, the boundary walls of the mixing chamber (viewed in the oscillation plane) thus enclose an angle which is preferably oriented to the oscillation plane of the oscillating first fluid. Said angle can be up to 10° smaller or up to 10° greater than the oscillation angle, or can assume a value between said two values. It is particularly preferable for said angle to be up to 5° smaller or up to 5° greater than the oscillation angle, or to assume a value between said two values. It is thus possible to prevent the oscillation of the first fluid in the mixing chamber being influenced in a disadvantageous manner. The oscillation angle of the first fluid can be at least 5°, preferably at least 25°, particularly preferably at least 40°. For many applications, an oscillation angle of between 25° and 50°, in particular between 30° and 45°, is suitable. A typical maximum value for the oscillation angle is 75°. In the outlet channel, too, the boundary walls of the mixing chamber (viewed in the oscillation plane) enclose an angle which is smaller than the angle between the boundary walls of the mixing chamber in the inlet channel. Particularly preferably, the angle of the outlet channel is up to 15° smaller than the angle of the inlet channel. In addition, the extension of the mixing chamber transversely to the oscillation plane in the inlet channel can increase with increasing distance from the first inlet opening, or the extension of the mixing chamber transversely to the oscillation plane in the outlet channel can decrease with increasing distance from the first inlet opening.

The (relative) size of the inlet channel and outlet channel of the mixing chamber can be configured depending on the application.

According to one embodiment, the second inlet opening of the mixing chamber is offset, relative to the first inlet opening of the mixing chamber, along the longitudinal axis of the mixing chamber. In this case, the second inlet opening is preferably provided inside the inlet channel (i.e. in a boundary wall of the inlet channel). Viewed along the longitudinal axis, the distance between the first and the second inlet opening can correspond to at least half the width of the first inlet opening of the mixing chamber, wherein the width is defined in parallel with the oscillation plane of the first fluid and transversely to the longitudinal axis of the mixing chamber.

The first inlet opening and the outlet opening of the mixing chamber can be formed on mutually opposing sides of the mixing chamber. For example, the first inlet opening can form the upstream end of the mixing chamber, and the outlet opening can form the downstream end. In particular, the first inlet opening and the outlet opening can be located on the longitudinal axis.

It is furthermore conceivable for the mixing chamber to be of a volume that is greater than the volume of the fluidic component or of the flow chamber of the fluidic component. In this case, in particular both the width (extension transversely to the longitudinal axis of the mixing chamber, and in the oscillation plane of the first fluid) and the length (extension along the longitudinal axis) of the mixing chamber can be greater than the width (extension transversely to the first fluid flow direction, and in the oscillation plane of the first fluid) or length (extension along the first fluid flow direction) of the flow chamber of the fluidic component. This volume ratio makes it possible to prevent an undesired high pressure being built up in the mixing chamber. Alternatively, the volume of the mixing chamber may be smaller than the volume of the flow chamber of the fluidic component. In this case, the width and/or the length of the mixing chamber may be smaller than the width or length of the flow chamber of the fluidic component.

With regard to the second supply device, it can be provided for this to be provided and configured to carry the second fluid, in the mixing chamber, as a (quasi) stationary flow.

Thus, the second supply device can for example be configured as a pipe, the longitudinal axis of which (or the downstream elongate end portion of which) specifies the second fluid flow direction of the fluid. The second fluid can be carried through the pipe and the second inlet opening, into the mixing chamber, by means of a pump device.

Alternatively, the second supply device (as is already the case for the first supply device) can likewise comprise a fluidic component. This fluidic component can operate according to the same principle as the fluidic component of the first supply device. It can thus comprise at least one means for specifically changing the direction of the second fluid that flows through the fluidic component, in particular in order to cause an oscillation in space of said fluid at the outlet opening. The remaining features of the fluidic component of the first supply device can also be transferred to the fluidic component of the second supply device. Thus, in the mixing chamber, a first oscillating fluid and a second oscillating fluid meet one another. The fluidic component of the second supply device can have a smaller oscillation angle than the fluidic component of the first supply device. The two oscillation angles can also be the same size.

The first and second fluid can in each case be supplied to the first and the second supply device, respectively, using a pump device. The pump devices preferably deliver constant volume flows. For example, the pump devices can be configured as syringe pumps or transfer pumps. As an alternative to syringe pumps, HPLC pumps or membrane pumps can be used.

According to a further embodiment, in addition to the above-mentioned (first) mixing chamber the device comprises a second mixing chamber. The second mixing chamber comprises (as the first mixing chamber does already) a first inlet opening, a second inlet opening, and an outlet opening. The second mixing chamber is fluidically connected to the first mixing chamber. In particular, the second mixing chamber adjoins the outlet opening of the first mixing chamber, in the downstream direction. In this case, the first inlet opening of the second mixing chamber can correspond to the outlet opening of the upstream first mixing chamber. Accordingly, the first and the second mixing chamber are directly interconnected, and not by using an additional (for example tubular) transition piece. The second mixing chamber can serve to introduce a further (third) fluid into the fluid mixture produced in the first mixing chamber. If the device according to the solution is used to produce particles during the mixing process, these particles can be built up in layers using the second mixing chamber, wherein the third fluid for example forms the outermost layer of the particles. The features of the first (upstream) mixing chamber with respect to the relative arrangement of the first and second inlet opening and to the shape (inlet channel, outlet channel) can also be transferred to the second mixing chamber. The volume (and width and length) of the second mixing chamber can be larger than in the case of the first mixing chamber.

A further embodiment provides that an interaction channel adjoins the outlet opening of the first mixing chamber or of the second mixing chamber, in the downstream direction, which interaction channel has at least one bend. The formation of what are known as wake spaces can be prevented by means of the at least one bend. The interaction channel can be configured in the manner of a pipe. The interaction channel can serve to continue the mixing process downstream of the outlet opening of the mixing chamber; and if particles are produced in the mixing process, these can grow in the interaction channel (in a manner controlled by the length of the interaction channel).

The device according to the solution makes it possible to allow the fluids to be mixed to meet one another in a relatively compact manner, at an angle. In this case, at least the first fluid moves back and forth locally in a plane, such that the first fluid can also be described as oscillating. The second fluid collides with the moving (oscillating) fluid at an angle. In order to better control the mixing, and to collect the produced fluid mixture, it is advantageous for the mixing process to be carried out in a relatively small volume.

The solution furthermore relates to a method for mixing fluids and for producing a fluid mixture. The method is carried out using the device according to the solution. In order to carry out the method, firstly a device according to the solution, a first fluid, and a second fluid are provided. The first fluid is introduced into the mixing chamber, at a first volume flow, via the first supply device. At the same time, the second fluid is introduced into the mixing chamber, at a second volume flow, via the second supply device. In the mixing chamber, the first and second fluid have the opportunity to mix and in the process to optionally form particles. In this case, the dwell time of the fluids in the mixing chamber may be different depending on the application. Subsequently, the fluid mixture comprising the first fluid and the second fluid is discharged out of the mixing chamber via the outlet opening thereof.

If particles are produced in the mixing process, the size thereof and the size distribution can thus be influenced by selecting the chemical substances of the first and second fluid, by the oscillation frequency of the first oscillating fluid, and by the geometry of the device used for the mixing process.

If an interaction channel adjoins the outlet opening of the mixing chamber in the downstream direction, the mixing process can be continued in the interaction channel. If particles are produced in the mixing process, these can grow further in the interaction channel.

According to one embodiment, the first volume flow is greater than the second volume flow. Depending on the application, however, the first and the second volume flow can be of the same size. It is conceivable that the first volume flow and the second volume flow are in each case constant over the duration of the mixing process. Preferably, the first fluid and the second fluid are in each case introduced continuously into the mixing chamber during the mixing process.

The volume flow of the first and second fluid is controlled by pump devices which pump the first and second fluid into the mixing chamber via the first and second supply device, respectively. Depending on the application, the pressure of the introduced fluid can be in the range of a few millibars (mbar) up to several hundred bar (relative to ambient pressure). For applications in mass production, the intake pressure can be over 2 bar. A pressure range between 2 bar and 350 bar is preferred, particularly preferably between 10 bar and 220 bar.

The fluids used can either comprise just one chemical substance, or a mixture of two or more chemical substances. The mixture can also contain a solvent. The method can be carried out using a first fluid and a second fluid which are different. The two different fluids can differ with respect to their chemical composition and/or the concentration of individual components. In the case of suspensions, the two fluids can also differ with respect to the particle size. However, it is also conceivable for the first fluid and the second fluid to be identical, i.e. to not differ from one another with respect to the mentioned properties. The turbulences prevailing in the mixing chamber make it possible for the size of the particles in the suspension, for example, to be varied, in the event of identical suspensions (as first and second fluid). In this case, the size distribution of the particles, or what is known as the encapsulation rate, can also be influenced.

According to one embodiment, the method is carried out using a liquid or a suspension as the first fluid. In this case, a suspension is to be understood to be a mixture of a liquid and particles distributed therein. The second fluid is also either a liquid or a suspension. However, it is also conceivable for at least one of the fluids to be gaseous.

The first fluid can for example comprise a solvent and a pharmaceutical or therapeutic component. The second fluid can be a liquid which is suitable for surrounding the pharmaceutical or therapeutic component of the first fluid during the mixing process, and to function as a carrier or vehicle for the pharmaceutical or therapeutic component, in the fluid mixture thus obtained. It is conceivable for the first fluid to be a suspension which contains a nucleic acid, and for the second fluid to comprise a lipid mixture. The nucleic acid may be DNA, RNA, or mRNA.

The fluids used for the method can typically be aqueous solutions. Furthermore, lipophilic and hydrophilic additives (emulsifiers, surfactants) and lipids can be used, such as triglycerides, mono- and diglycerides, partial glycerides, or also partially synthetic or synthetic waxes can be used. Furthermore, the device is also suitable for the use of polyethylene glycol (PEG) as the first or second fluid.

For some mixing processes, the use of water-soluble and/or non-water-soluble organic solvents (e.g. ethanol) may be necessary. These solvents can be used as the first or second fluid, or can be contained in the first or second fluid. In a method step for purifying the produced fluid mixture, said solvent can be largely removed again.

The device proposed here for mixing fluids, and the method that makes use of the device, can be used for self-organizing structure formation processes, multi-stage particle formation processes, crystallization processes, multi-stage biochemical structure formation processes, and for the formation and loading of multi-shell particles, as well as for precipitation processes and for producing dispersions (in particular suspensions and emulsions). Furthermore, the device and the method are suitable for producing liquid crystalline nanoparticles, such as cubosomes or hexosomes. The produced substances can be used for example in pharmaceutics, process engineering, cosmetics, or food production.

The device according to the solution can be manufactured using cutting or machining manufacturing methods, replicative methods, for example by means of injection molding, or additive methods (3D printing). Likewise, methods comprising a specific blade (e.g. milling) or machining methods (e.g. electrical discharge machining) are also suitable for the manufacturing.

The device according to the solution can be manufactured from various materials.

Plastics materials (PEEK, PVDF, COC), metals, or alloys (stainless steel, aluminum), glass, or ceramics are possible as materials.

The device can be configured to be fluid-tight and pressure-resistant, by means of a sealing system. The sealing system can comprise a direct-sealing cover structure, a sealing intermediate structure, or a contour-following, structured seal. The sealing surfaces of the direct-sealing cover structure and the sealing intermediate structure can advantageously be manufactured from materials which have a surface roughness Ra≤200 nm and an evenness E≤5 μm. A surface roughness Ra≤50 nm and an evenness E≤1 μm are particularly advantageous. In order to provide sealing surfaces with the specified roughness or evenness, the surface properties can be produced directly or adjusted by post-processing (grinding, polishing or ultra-precision machining).

Fluid-conducting components of the device can have a defined fine surface form, which advantageously influences the flow behavior of the fluids flowing through the components. For example, the materials of the fluid-conducting components can have a surface roughness Ra≤0.5 μm, particularly preferably Ra≤0.38 μm, in order to prevent an accumulation of components of the fluids on the fluid-conducting components. In one embodiment, the surfaces of the fluid-conducting components are hydrophilic, having a contact angle β≤90°. The contact angle denotes the angle which is formed by a liquid droplet on the surface of a solid, with respect to said surface. The surface properties of the fluid-conducting components can be adjusted by the selection of the material (stainless steel, PEEK or COC), and by means of surface functionalization (plasma treatment, chemical functionalization, or microstructuring).

### BRIEF DESCRIPTION OF THE DRAWINGS

The terms Fig., Figs., Figure, and Figures are used interchangeably in the specification to refer to the corresponding figures in the drawings.

The solution will be explained in greater detail in the following, with reference to embodiments and in conjunction with the drawings.

FIG. 1 is a cross section through a device for mixing fluids and for producing a fluid mixture according to one embodiment;

FIG. 2-4 are sectional views of the device from FIG. 1 along the lines A′-A″, B′-B″ and C′-C″, respectively;

FIG. 5 is a cross section through a device for mixing fluids and for producing a fluid mixture according to a further embodiment;

FIG. 6 is a cross section through a device for mixing fluids and for producing a fluid mixture according to a further embodiment;

FIG. 7 is a cross section through a device for mixing fluids and for producing a fluid mixture according to a further embodiment;

FIG. 8 is a schematic view of an interaction channel according to one embodiment, as part of a device for mixing fluids and for producing a fluid mixture;

FIG. 9 shows the deflection of the oscillating first fluid as a function of time, upon entry into the mixing chamber of the device for mixing fluids and for producing a fluid mixture;

FIG. 10 is a schematic illustration of a method for mixing fluids and for producing a fluid mixture;

FIGS. 11 (a)-(c) show measured values of the fluid mixture, obtained by means of the method from FIG. 10 and using the device from FIG. 5, at different volume flows;

FIG. 12 is a cross section through a device for mixing fluids and for producing a fluid mixture according to a further embodiment;

FIG. 13 is a sectional view of the device from FIG. 12 along the line D′-D″; and

FIG. 14 is a schematic illustration of a method for mixing fluids and for producing a fluid mixture.

### DESCRIPTION OF THE INVENTION

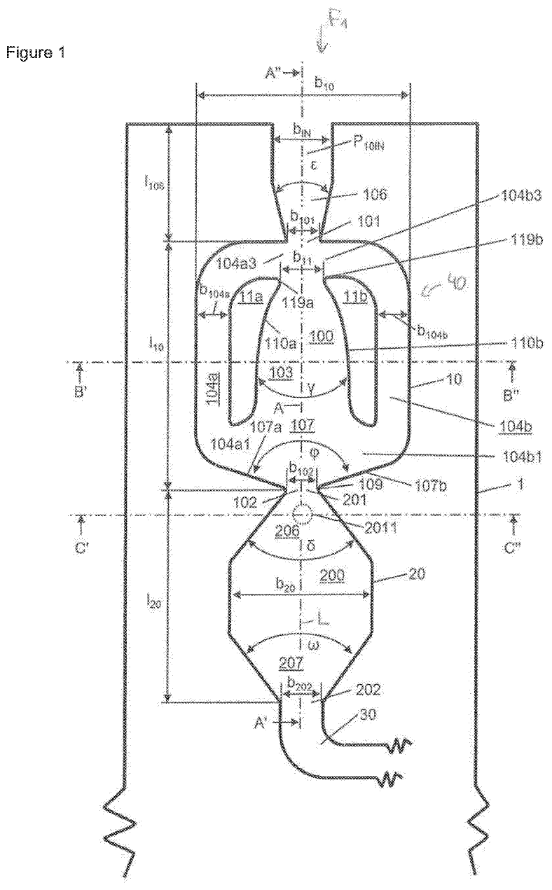

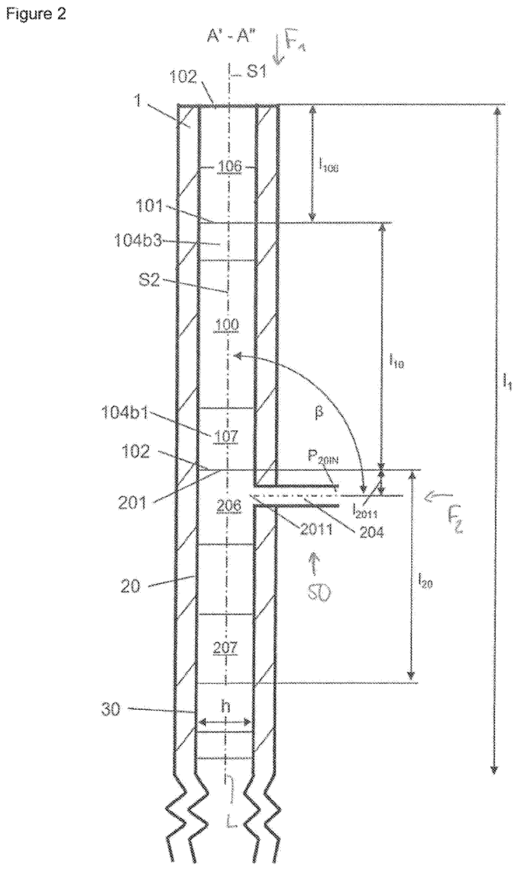

FIG. 1 schematically shows a device 1 for mixing fluids and for producing a fluid mixture according to one embodiment of the solution. FIG. 2 to 4 are in each case sectional views of said device 1 along the lines A′-A″, B′-B″ and C′-C″, respectively.

The device 1 comprises a mixing chamber 20, a first supply device 40, a second supply device 50, and an interaction channel 30.

In this case, the mixing chamber 20 forms the central element of the device 1. The mixing chamber 20 comprises a first inlet opening 201, a second inlet opening 2011, and an outlet opening 202. A first fluid 7 can be introduced into the mixing chamber 20 via the first inlet opening 201, and a second fluid 8 can be introduced into said chamber via the second inlet opening 2011. In the mixing chamber 20, the first and the second fluid 7, 8 form a fluid mixture 9, which can be discharged via the outlet opening 202 of the mixing chamber 20.

The first supply device 40 is (fluidically) connected to the mixing chamber 20 via the first inlet opening 201 and serves to introduce the first fluid 7 into the mixing chamber 20.

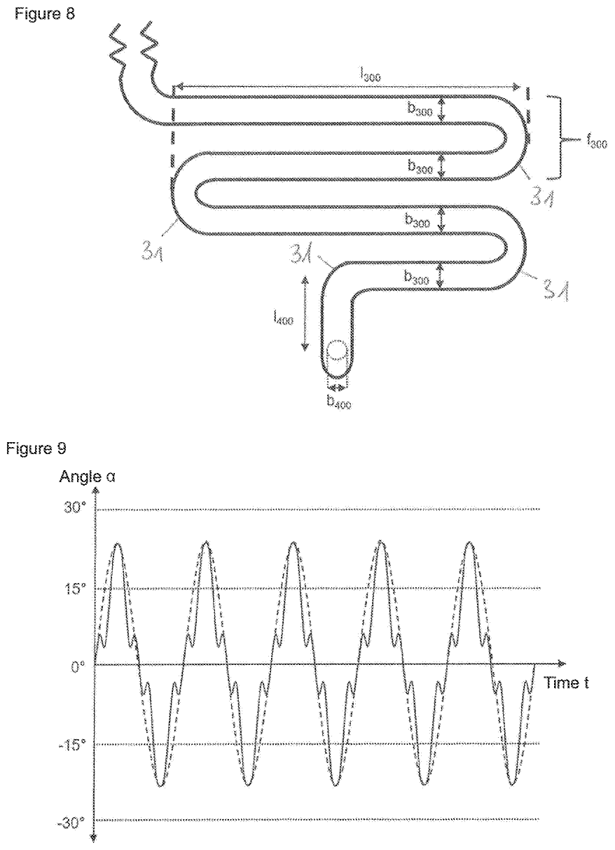

The second supply device 50 is (fluidically) connected to the mixing chamber 20 via the second inlet opening 2011 and serves to introduce the second fluid 8 into the mixing chamber 20. The interaction channel 30 adjoins the outlet opening 202, in the downstream direction. An embodiment of the interaction channel 30 by way of example is shown in FIG. 8 and is explained below.

The first supply device 40 comprises a fluidic component 10 having two auxiliary flow channels (feedback channels) 104a, 104b as the means for producing a first fluid 7 moving in space and/or in time, and in particular for causing an oscillation in space of the first fluid 7.

The energy for producing the fluid jet moving in space and/or in time results from the intake pressure P_{10IN} of the first fluid 7 (also referred to as first phase A). The use of the fluidic component 10 has the advantage that no additional energy source has to be used, and thus the complexity and the susceptibility to faults of the device can be reduced. Furthermore, it is thus possible to ensure that no additional external energy is introduced into the fluid 7 that flows through the fluidic component 10. Input of additional energy should be prevented. Otherwise, sensitive components of the fluids (for example long-chain molecules) can be destroyed by input of additional energy.

The fluidic component 10 shown in FIG. 1, comprising the auxiliary flow channels 104a, 104b is merely by way of example. In principle, other fluidic components can also be used, such as what are known as feedback-free components.

The fluidic component 10 comprises a flow chamber 100 through which a first fluid (flow) 7 can flow. The fluidic component 10 has the function of bringing about an oscillation of the first fluid 7, such that the first fluid 7 oscillates in time and/or locally upon entering the mixing chamber through the first inlet opening 201 of the mixing chamber 20.

The flow chamber 100 comprises an inlet opening 101 having an inlet width b₁₀₁, via which the first fluid flow 7 enters the flow chamber 100, and an outlet opening 102 having an outlet width b₁₀₂, via which the first fluid flow 7 emerges from the flow chamber 100. The inlet opening 101 and the outlet opening 102 are in each case defined where the cross-sectional area (transversely to the fluid flow direction) of the fluidic component 10, through which the fluid flow passes when it enters the flow chamber 100 or emerges from the flow chamber 100 again, is smallest in each case.

The widths b₁₀₁ and b₁₀₂ of the inlet and outlet opening 101, 102, respectively, correspond to the extension of the inlet and outlet opening 101, 102, respectively, transversely to the fluid flow direction and within the oscillation plane (to be explained later) of the first fluid 7.

The outlet opening 102 of the flow chamber 100 of the fluidic component 10 corresponds, here, to the first inlet opening 201 of the mixing chamber 20.

The inlet width b₁₀₁ can have dimensions of from 0.5 μm to 5000 μm. The size of the narrowest cross-sectional areas within the fluidic component 10 (cross section A₁₀₂ of the outlet opening 102 or smallest cross-sectional area A₁₁ in the main flow channel 103 between the inner blocks 11a, 11b) in the device 1 can be selected depending on the desired volume flow. The greater the volume flow, at a constant intake pressure P_{10IN}, the greater the dimension e.g. of the inlet width b₁₀₁ and/or the inlet height h₁₀₁ has to be. Typical dimensions are 100 μm to 3500 μm, preferably 200 μm to 1500 μm.

The inlet opening 101 and the outlet opening 102 are arranged on two sides of the fluidic component 10 that are opposite one another in terms of flow. The flow chamber 100, more precisely a main flow channel 103 of the flow chamber 100, interconnects the inlet opening 101 and the outlet opening 102 in an obstruction-free manner. In a variant that is not shown, the inlet opening 101 and the outlet opening can be connected by means of a flow chamber 100 that is not obstruction-free.

The first fluid flow 7 moves in the flow chamber 10 substantially along a longitudinal axis A of the fluidic component 1 (which interconnects the inlet opening 101 and the outlet opening 102) from the inlet opening 101 to the outlet opening 102. The longitudinal axis A forms an axis of symmetry of the fluidic component 1. The longitudinal axis A is located in two mutually perpendicular symmetry planes S1 and S2, relative to which the fluidic component 1 is mirror-symmetric. Alternatively, the fluidic component 1 can be configured so as not to be (mirror-)symmetric.

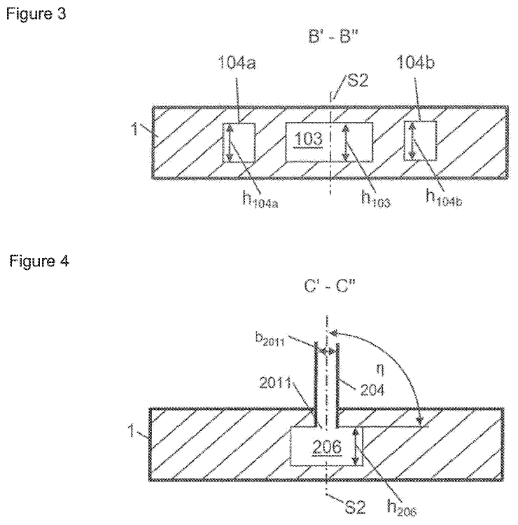

For specifically changing the direction of the fluid flow, the flow chamber 100 comprises two auxiliary flow channels 104a, 104b, in addition to the main flow channel 103. The main flow channel 103 and the two auxiliary flow channels 104a, 104b extend substantially along the longitudinal axis A of the fluidic component 10, wherein the main flow channel 103 (viewed transversely to the longitudinal axis A) is arranged between the two auxiliary flow channels 104a, 104b. Directly behind the inlet opening 101, the flow chamber 10 divides into the main flow channel 103 and the two auxiliary flow channels 104a, 104b, which are then combined again directly in front of the outlet opening 102. In the embodiment shown here the two auxiliary flow channels 104a, 104b are arranged symmetrically with respect to the symmetry plane S2 (FIG. 3). According to an alternative that is not shown, the auxiliary flow channels are arranged non-symmetrically. The auxiliary flow channels can also be positioned outside of the flow plane shown. These channels can be implemented for example by means of tubes which are also located outside of the symmetry plane S1, or can extend through channels that are located at an angle to the flow plane (symmetry plane S1).

The main flow channel 103 interconnects the inlet opening 101 and the outlet opening 102 substantially in a straight line, such that the fluid flow 7 flows substantially along the longitudinal axis A of the fluidic component 10. The main flow channel 103 can typically assume a volume of from 0.08 mm³ to 260 mm³. A volume of the main flow channel 103 of from 0.3 mm³ to 120 mm³ is particularly preferred. In the embodiment shown, the volume of the main flow channel 103 is approximately 0.67 mm³. The fluidic component 10 has a fluid-containing volume of between 0.5 mm³ and 1.2 mm³, wherein the smallest cross-sectional area A₁₀₂ at the outlet opening 102 is approximately 0.09 mm².

In the embodiment shown, the cross-sectional area A₁₀₁ at the inlet opening 101 is approximately 0.12 mm².

Proceeding from the inlet opening 101, the auxiliary flow channels 104a, 104b in each case initially extend, in a first portion, in opposite directions at an angle of substantially 90° relative to the longitudinal axis A. Subsequently, the auxiliary flow channels 104a, 104b fork, such that they extend in each case substantially in parallel with the longitudinal axis A (in the direction towards the outlet opening 102) (second portion). In order to combine the auxiliary flow channels 104a, 104b and the main flow channel 103 again, the auxiliary flow channels 104a, 104b again change direction at the end of the second portion, such that they are in each case directed substantially in the direction towards the longitudinal axis A (third portion). In the embodiment of FIG. 1, the direction of the auxiliary flow channels 104a, 104b changes, at the transition from the second into the third portion, by an angle of approximately 120°. However, angles different from that mentioned here can be selected, or even an entirely different course can be followed, for the change in direction between these two portions of the auxiliary flow channels 104a, 104b.

The auxiliary flow channels 104a, 104b are a means for influencing the direction of the first fluid flow 7 which flows through the flow chamber 100. For this purpose, the auxiliary flow channels 104a, 104b each comprise an intake 104a1, 104b1, which is formed by the end of the auxiliary flow channels 104a, 104b facing the outlet opening 102, and each comprise an output 104a3, 104b3, which is formed by the end of the auxiliary flow channels 104a, 104b facing the inlet opening 101. A smaller portion of the first fluid flow 7, the auxiliary flows, flows through the inputs 104a1, 104b1 and into the auxiliary flow channels 104a, 104b. The remaining portion of the first fluid flow 7 (referred to as the main flow) emerges from the fluidic component 10 via the outlet opening 102. The auxiliary flows emerge from the auxiliary flow channels 104a, 104b at the outputs 104a3, 104b3, where they can exert a lateral impulse (transversely to the longitudinal axis A) on the first fluid flow 7 entering through the inlet opening 101. In this case, the direction of the first fluid flow 7 is influenced in such a way that the main flow emerging at the outlet opening 102 oscillates in space, and specifically in a plane in which the main flow channel 103 and the auxiliary flow channels 104a, 104b are arranged. The planes in which the main flow oscillates is also referred to as the oscillation plane and substantially corresponds to the symmetry plane S1 or is in parallel with the symmetry plane S1.

In the embodiment shown here, the auxiliary flow channels 104a, 104b each have a cross-sectional area which is virtually constant over the entire length (from the intake 104a1, 104b1 to the output 104a2, 104b2) of the auxiliary flow channels 104a, 104b. In contrast, the size of the cross-sectional area of the main flow channel 103 increases substantially constantly in the flow direction of the main flow (i.e. in the direction from the inlet opening 101 to the outlet opening 102). In this case, the shape of the main flow channel 103 is, by way of example, mirror-symmetric with respect to the symmetry planes S1 and S2.

However, the cross-sectional area of the main flow channel 103 can in principle also decrease in the downstream direction.

The main flow channel 103 is separated from each auxiliary flow channel 104a, 104b by a block 11a, 11b. In the embodiment, the two blocks 11a, 11b are arranged so as to be symmetrical with respect to the mirror plane S2. In principle, however, they can also be configured differently and oriented non-symmetrically. In the case of a non-symmetrical orientation, the shape of the main flow channel 103 is likewise not symmetrical with respect to the mirror plane S2. A symmetrical embodiment of the two blocks 11a, 11b is preferred.

The shape of the blocks 11a, 11b shown in FIG. 1 is merely by way of example and can be varied. The blocks 11a, 11b from FIG. 1 have rounded edges. Sharp edges are also possible. The variant having rounded edges is preferred.

A funnel-shaped attachment 106 is connected to the inlet opening 101 of the flow chamber 100, in the upstream direction, which attachment tapers in the direction towards the inlet opening 101 (downstream). In principle, an attachment 106 is also possible which has a substantially constant cross section or a widened cross-sectional area in portions. Said funnel-shaped attachment can also be referred to as the inlet channel. The flow chamber 100 also tapers, and specifically in the region of the outlet opening 102, downstream of the inner blocks 11a, 11b. The tapering is formed by an outlet channel 107 and begins at the auxiliary flow channel inlet 104a1, 104b1. In this case, the attachment 106 and the outlet channel 107 taper in such a way that only the width thereof, i.e. the extension thereof in the symmetry plane S1 perpendicularly to the longitudinal axis A, reduces downstream in each case. In this embodiment, the tapering does not have any effect on the depth (i.e. the extension in the symmetry plane S2 perpendicularly to the longitudinal axis A) of the attachment 106 and of the outlet channel 107 (FIG. 2). Alternatively, the attachment 106 and the outlet channel 107 can also taper in width and in depth in each case. Furthermore, it is possible that only the attachment 106 tapers in depth or in width, while the outlet channel 107 tapers both in width and in depth, and vice versa. The shape of the attachment 106 and of the outlet channel 107 is shown in FIG. 1 merely by way of example. Here, the width reduces in a linear manner, in the downstream direction, wherein the boundary walls of the attachment 106 and of the outlet channel 107 (in each case viewed in the oscillation plane) enclose an angle of ε and φ, respectively. Other shapes of the tapering are possible. The length l₁₀₆ of the inlet channel, or in this example of the funnel-shaped attachment 106, corresponds, in this embodiment, to at least 1.5 times the inlet width b₁₀₁, i.e. the following applies: l₁₀₆≥1.5× b₁₀₁. According to a preferred embodiment, the length l₁₀₆ of the funnel-shaped attachment 106 is more than 3 times the width b₁₀₁. In the case of a given and fixed value of the width b₁₀₁ the following applies: the smaller the angle ε, the longer the inlet channel 106 should be.

The inlet opening 101 and the outlet opening 102 have an idealized rectangular cross-sectional area in each case. These are of the same depth (extension in the symmetry plane S2 perpendicularly to the longitudinal axis A, FIG. 2) in each case, but differ in their width b₁₀₁, b₁₀₂ (extension in the symmetry plane S1 perpendicularly to the longitudinal axis A, FIG. 2). In principle, the corners of the cross-sectional area can be rounded, and the opposing surfaces which define the inlet and outlet opening 101, 102 do not have to extend in parallel. In an extreme case, the inlet opening 101 and the outlet opening 102 can also have circular or elliptical cross-sectional areas.

The outlet opening 102 of the flow chamber 100 of the fluidic component 10 corresponds, here, to the first inlet opening 201 of the mixing chamber 20. It is advantageous if, in general (i.e. for all the embodiments) the cross-sectional area A₁₀₂ of the outlet opening 102 is the smallest or equal to the smallest cross-sectional area of the cross-sectional areas A₁₀₁, A₁₁ and A₁₂, i.e. the following applies: A₁₀₂≤min(A₁₀₁, A₁₁), in particular if the cross-sectional area A₁₀₂ of the outlet opening 102 is the smallest cross-sectional area of the flow chamber 100 of the fluidic component 10. The cross-sectional area A₁₀₂ of the outlet opening 102 and the cross-sectional area A₂₀₁ of the first inlet opening 201 are of the same size, and likewise the width b₁₀₂ and the width b₂₀₁, and the height h₁₀₂ and the height h₂₀₁ are of the same size. At the outlet opening 102 or the first inlet opening 201 the tapering outlet channel 107 of the fluidic component 10 and the widening inlet channel 206, explained later, of the mixing chamber 20 meet one another, such that an edge is formed in this transition region.

Said transition region can be rounded. The rounding can have a radius 109 which is smaller than the minimum width of b₁₀₁ (width of the inlet opening 101) and b₁₁ (associated width of the smallest cross-sectional area A₁₁ in the main flow channel 103 between the inner blocks 11a, 11b). An extreme value, which results in a sharp-edged outlet 102, is a radius of zero. On account of the higher mechanical stability, a radius 109 is preferred.

An inlet channel 206 adjoins downstream of the first inlet opening 201 of the mixing chamber 20. The inlet channel 206 has a cross-sectional area (transversely to the first fluid flow direction or the longitudinal axis L of the mixing chamber 20) which enlarges in the downstream direction. In this case, in particular the width (extension in the oscillation plane and transversely to the longitudinal axis L) of the inlet channel 206 increases in the downstream direction. The width increases linearly in this case.

However, the increase in the width can also follow a polynomial. Viewed in the oscillation plane, the walls defining the inlet channel 206 enclose an angle δ. Said angle δ can have different dimensions. An angle δ which is selected depending on the oscillation angle α is advantageous. In this case, a deviation from the oscillation angle α of +10° and −10° is possible, i.e. α−10°<δ<α+10°. A particularly preferred value for the angle δ is α−5°<δ<α+5°. In this case, the oscillation angle α corresponds to the natural oscillation angle which would result in the absence of the inlet channel 206 and the mixing chamber 20.

The cross-sectional area A₂₀₀ (transversely to the longitudinal axis L) of the mixing chamber 20 increases constantly in the inlet channel 206. In this case, the cross-sectional area at the inlet opening 201 is for example 0.09 mm², and increases to more than double, along the longitudinal axis L up to the center point of the second inlet opening 2011. In the center point of the second inlet opening 2011, the cross-sectional area has the value 0.26 mm². In this variant, the cross-sectional area A₂₀₁₁ of the second inlet opening 2011 is smaller than that of the first inlet opening 201, and assumes the value 0.07 mm².

In the embodiment of FIG. 1, the width b₂₀ of the mixing chamber 20 is smaller than the width b₁₀ of the fluidic component 10. Furthermore, the length l₂₀ of the mixing chamber 20 is smaller than the length ho of the fluidic component 10. The width is in each case the extension in the oscillation plane of the first fluid 7 and transversely to the longitudinal axis A, L of the fluidic component 10 or of the mixing chamber 20. The length is in each case the extension in the oscillation plane of the first fluid 7 and along the longitudinal axis A, L of the fluidic component 10 or of the mixing chamber 20.

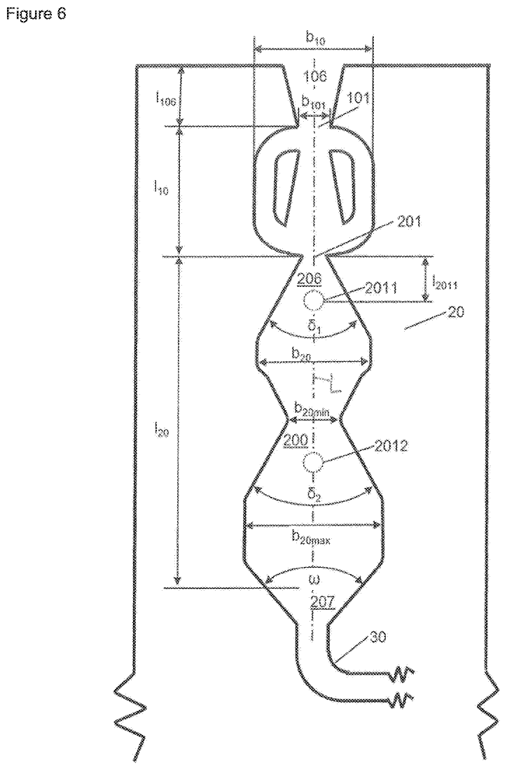

In this embodiment that is shown, the width b₂₀ of the mixing chamber 20 is defined by two approximately parallel surfaces, which function as boundary walls in an intermediate portion of the mixing chamber 20. The intermediate portion is formed along the first fluid flow direction F₁, between the inlet channel 206 and an outlet channel 207 of the mixing chamber 20. In principle, the boundary walls can also be shaped differently (as flat and parallel), as indicated for example in FIG. 6.

The outlet channel 207 adjoins at the downstream end of the intermediate portion. The cross-sectional area thereof (transversely to the first fluid flow direction or the longitudinal axis L of the mixing chamber 20) reduces along the longitudinal axis L, in the downstream direction. In this case, in particular the width (extension in the oscillation plane and transversely to the longitudinal axis L) of the outlet channel 207 decreases in the downstream direction. The width decreases linearly in this case.

However, the decrease in the width can also follow a polynomial. Viewed in the oscillation plane, the walls defining the outlet channel 207 enclose an angle ω. It is advantageous if the angle ω is smaller than the angle δ. It is particularly advantageous if the angle ω is up to 15° smaller than the angle δ. The downstream end of the outlet channel 207 is formed by the outlet opening 202. The fluid mixture 9 of the first and second fluid 7, 8 leaves the mixing chamber 20 through said outlet opening 202.

The outlet opening 202 has a cross-sectional area A₂₀₂, which is rectangular here, by way of example, and therefore has a width b₂₀₂ and a height h₂₀₂. In principle, a non-rectangular cross-sectional area of the outlet opening 202 is also possible. The cross-sectional area A₂₀₂ is greater than the smallest cross-sectional area A_{1 min} from the means for producing a fluid jet 10 moving in space (A₁₀₁, A₁₁ or A₁₀₂, i.e. A_{1 min}=min(A₁₀₁, A₁₁, A₁₀₂)). The cross-sectional area A₂₀₂ is the same size as or greater than the sum of half the cross-sectional area A₂₀₁₁ of the second inlet opening 2011 and the entire cross-sectional area A_{1 min}, or, in other words: A₂₀₂≥A_{1 min}+0.5× A₂₀₁₁. A₂₀₂≥A_{1 min}+A₂₀₁₁ is particularly preferred.

In an embodiment that is not shown, a plurality of outlet openings 202 can also be provided, which lead into different interaction channels 30. Some of the plurality of outlet openings 202 can also lead into correspondingly provided interaction channels, and others can be formed without interaction channels. For the sum of the cross-sectional areas A₂₀₂ of the plurality of outlet openings 202, the same comments apply as described above.

FIG. 2 is a sectional view of the device 1 from FIG. 1 along the line A′-A″. According thereto, in this embodiment the fluidic component 10, the mixing chamber 20, and at least the upstream end of the interaction channel 30 are of a constant height h. The height (also referred to as depth) is the extension transversely to the oscillation plane of the first fluid 7. In an embodiment which is not shown, the height h may be non-constant. In particular in the region of the inlet channels 106 and 206 and the outlet channels 107 and 207, the height h may deviate from the height in the remainder of the device.

The second supply device 50, which is provided for introducing the second fluid 8 into the mixing chamber 20, comprises a pipe 204 which extends along a longitudinal axis and specifies the fluid flow direction F₂ for the second fluid 8. The pipe 204 is connected to the mixing chamber 20 via the second inlet opening 2011 of the mixing chamber 20.

The pipe 204 (viewed in the symmetry plane S2 or a plane which extends perpendicularly to the oscillation plane and along the longitudinal axis L) is at an angle β relative to the oscillation plane of the fluidic component 10 or the symmetry plane S1. In this embodiment, the angle β=90°. In principle, the angle can assume another value. As a result, the mixing quality and/or the mixing path length or the mixing time is influenced. In order to reduce the pressure loss, a value of 45°±10° for the angle β is preferred. If particles are produced in the mixing process, then an angle of greater than 90° is advantageous for reducing the particle size.

FIG. 3 is a sectional view of the device 1 from FIG. 1 along the line B′-B″. In this sectional view, the cross-sectional area of the main flow channel 103 and of the auxiliary flow channels 104a, 104b of the fluidic component 10 are visible. In this embodiment, the heights h₁₀₃, h₁₀₄ₐ, h_{104b} of the channels 103, 104a, 104b are the same. However, they can in principle also deviate from one another. In FIG. 3, the cross-sectional areas of the main and auxiliary flow channels 103, 104a, 104b are shown simplified having sharp edges. However, the corners can be provided with radii, i.e. be rounded.

FIG. 4 is a sectional view of the device 1 from FIG. 1 along the line C′-C″. In this sectional view, a cross section through the inlet channel 206 of the mixing chamber 20 is visible. Again, in a simplified manner, the corners are not shown having radii although these can be present. The spacing of the lateral boundary walls of the inlet channel 206 (in parallel with the oscillation plane and transversely to the longitudinal axis L) is constant over the entire height h₂₀₆. However, the spacing can also change along the height h₂₀₆.

It can also be seen in FIG. 4 that the second inlet opening 2011 of the mixing chamber 20 is formed in the inlet channel 206 thereof. Viewed in a plane transversely to the longitudinal axis L, the pipe (supply channel 204) encloses an angle η together with the oscillation plane. In the embodiment shown, the angle η=90°. In principle, the angle can assume another value, e.g. can be between 30° and 150°. An angle η of 90° is preferred, in particular in the case of a variant comprising a second inlet opening 2011.

However, it can also be provided for the mixing chamber to comprise a plurality of second inlet openings, via which the mixing chamber is connected to a corresponding number of second supply devices (configured as pipes). In this embodiment (not shown) it may be advantageous for the respective angle η to assume a value different from 90°.

An advantageous variant comprising a plurality of second inlet openings and corresponding second supply devices inlet channels 204 is when these are formed alternately on the cover surface (shown at the top in FIG. 4) and the base surface (shown at the bottom in FIG. 4) opposite the cover surface, of the mixing chamber 20.

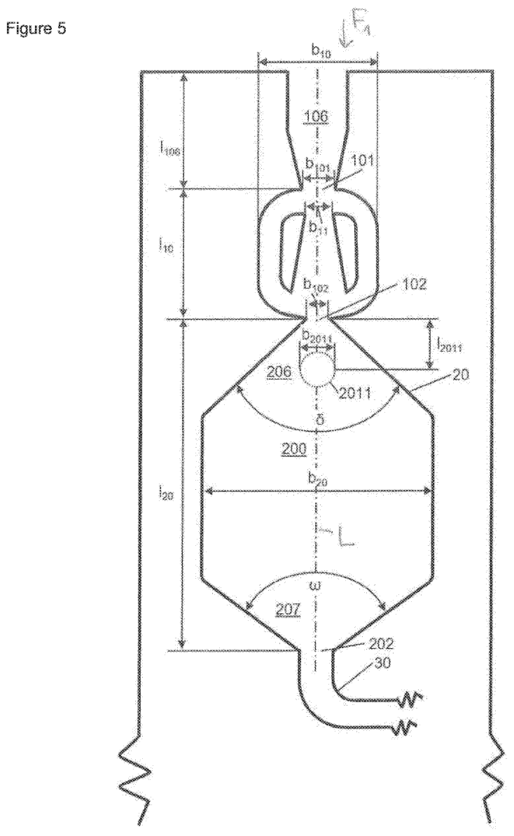

FIG. 5 shows a device 1 according to a further embodiment of the solution. This embodiment differs from the embodiment of FIG. 1 to 4 in particular in the design of the fluidic component 10 and in the size ratio of the volume of the flow chamber 100 of the fluidic component 10 and the mixing chamber 20.

The volume of the mixing chamber 20 is larger than the volume of the flow chamber 100 of the fluidic component 10. Specifically, in this embodiment both the width b₂₀ of the mixing chamber 20 and the length l₂₀ of the mixing chamber 20 are greater than the width b₁₀ of the fluidic component 10 and the length h of the fluidic component 10, respectively. Thus the following ratios apply: b₂₀>b₁₀ and l₂₀>l₁₀. According to a preferred embodiment, the fluid-conducting volume V₁₀ of the flow chamber 100 of the fluidic component 10 is significantly smaller than the volume V₂₀ of the mixing chamber 20: V₂₀>V₁₀. Preferably, the following applies: V₂₀>2× V₁₀.

In this embodiment, a second inlet opening 2011 is provided for the second fluid flow 8 (or a phase B). However, in principle further second inlet openings can be provided in the mixing chamber, which openings are provided to also introduce phase B or other phases into the mixing chamber 20.

In this embodiment, too, the second inlet opening 2011 for the second fluid flow 8 (or phase B) is located inside the inlet channel 206 of the mixing chamber 20. In principle, the (at least one) second inlet opening 2011 can be positioned freely inside the mixing chamber 20. The (at least one) second inlet opening 2011 is preferably positioned in the inlet channel 206 or in the outlet channel 207 of the mixing chamber 20. It is particularly preferable for at least one second inlet opening 2011 to be positioned in the inlet channel 206.

The spacing between at least one second inlet opening 2011 and the first inlet opening 201 along the longitudinal axis L is shown in FIG. 5 by the length l₂₀₁₁. It is advantageous for the length l₂₀₁₁ to correspond to at least half the width b₂₀₁ of the first inlet opening 201, i.e. l₂₀₁₁≥0.5× b₂₀₁ applies. It is particularly advantageous for the length l₂₀₁₁ to correspond to at least the sum of half the width b₁₀₂ of the first inlet opening 201 and half the width b₂₀₁ of the second inlet opening 2011: l₂₀₁₁≥0.5× (b₂₀₁+b₂₀₁₁). It is also advantageous for the length l₂₀₁₁ to be no more than five times the width b₂₀₁ of the first inlet opening 201; i.e. overall the following applies: 5× b₂₀₁≥l₂₀₁₁≥0.5×(b₁₀₂+b₂₀₁₁).

In the embodiment of FIG. 5, the second inlet opening 2011 is circular and is of the width b₂₀₁₁, which corresponds to the diameter of the circle. In principle, a shape deviating from a circle is also possible for the second inlet opening 2011. In this embodiment, the surface area A₂₀₁₁ of the second inlet opening 2011 is slightly smaller than the surface area A₁₀₂ of the outlet opening 102 of the fluidic component 10. (Here, the outlet opening 102 of the fluidic component 10 corresponds to the first inlet opening 201 of the mixing chamber 20, such that the surface area A₂₁₁ of the second inlet opening 2011 is also slightly smaller than the surface area A₂₀₁ of the first inlet opening 201.) The surface area A₁₀₂ is defined by the outlet width b₁₀₂ and the outlet depth. In the embodiment from FIG. 5, the cross-sectional area A₁₀₂ (transversely to the longitudinal axis L) of the mixing chamber 20 increases constantly in the inlet channel 206. The cross-sectional area A₂₀ is defined by the width b₂₀ and the height ha (extension transversely to the oscillation plane of the first fluid). In the region of the inlet channel 206, the cross-sectional area A₂₀ of the mixing chamber 20 can be referred to as the cross-sectional area A₂₀₆, and the associated width and height as the width b₂₀₆ and height h₂₀₆. It is advantageous for the cross-sectional area A₂₀ to have a jump-like change in size at a distance of approximately l₂₀₁₁−(b₂₀₁₁/2) from the first inlet opening 201 (along the longitudinal axis L). In this case, it is particularly advantageous for the jump-like change in size to be achieved by increasing the height h₂₀.

In the case of the fluidic component 10 shown in FIG. 5, the widths b₁₀₁, b₁₁ and b₁₀₂ are approximately of the same size. For example, they can be approximately 0.3 mm. The radius 109 at the outlet opening 102 can then be approximately 0.025 mm.

FIG. 6 shows a further embodiment of the solution. This embodiment differs from those of FIG. 1 to 5 in particular in that the mixing chamber is formed in multiple parts. That is to say that the mixing chamber comprises a plurality of (here, by way of example, two) sub-chambers 20, 20′ which are arranged one behind the other along the longitudinal axis L. Accordingly, with respect to the fluidic component 10 and the first fluid flow direction there is an upstream sub-chamber 20 which directly adjoins the outlet opening 102 of the fluidic component 10, and a downstream sub-chamber 20′ which directly adjoins the outlet opening 202 of the upstream sub-chamber 20. The first inlet opening of the downstream sub-chamber 20′ corresponds to the outlet opening of the upstream sub-chamber 20. In this case, each sub-chamber 20, 20′ comprises an inlet channel 206, 206′ that increases in size in the downstream direction, along the longitudinal axis L, and an outlet channel 207, 207′ that tapers in the downstream direction, along the longitudinal axis L. A second inlet opening 2012 is also formed in the inlet channel of the downstream sub-chamber. The two sub-chambers can also be considered as a mixing chamber 20 having a central constriction. Said mixing chamber 20 is then configured in such a way that the cross-sectional area A₂₀ of the mixing chamber 20 increases in the downstream direction, before and after the second inlet opening 2011, up to a certain point, remains constant in the further course, and then reduces again to a (local) minimum. Downstream of the (local) minimum, the cross-sectional area A₂₀ increases again. The further inlet opening 2012 is located in this region. In the further course, the mixing chamber 20 comprises the features described in connection with the embodiments from FIGS. 1 and 5. Portions having a cross-sectional area A₂₀ that is constant along the longitudinal axis L are optional.

It is particularly advantageous if the first part of the mixing chamber (or the upstream sub-chamber 20) comprising the second inlet opening 2011 to be configured such that alternating vortices can form, in order to thereby amplify the movement of the first fluid 7 and the moving mixed fluid jet 9. Therefore, the first part of the mixing chamber (or the upstream sub-chamber 20) is shaped such that in each case the two boundary walls, which are opposite one another when viewed in the oscillation plane and past which the jet of the first fluid 7, moving in time, flows alternately, form a pocket-like structure for the formation of an alternating vortex.

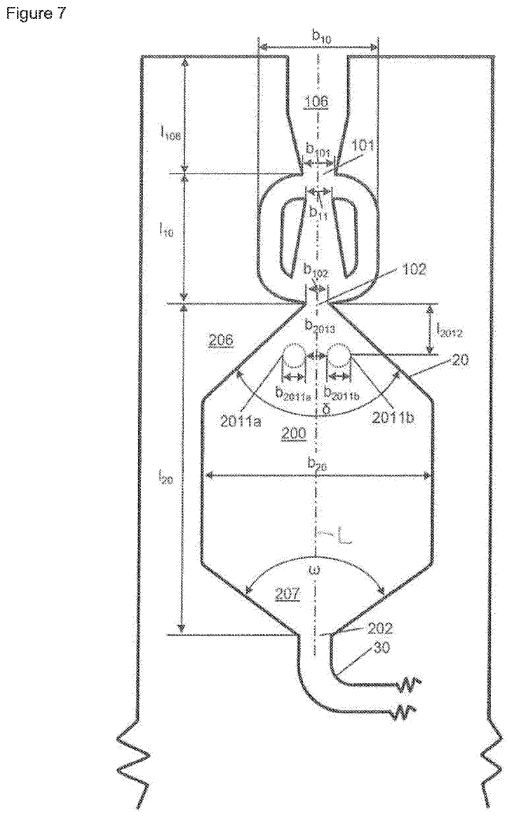

A further embodiment of the device 1 is shown in FIG. 7. This embodiment differs from the embodiments from FIGS. 1, 5 and 6 in particular in the shape of the mixing chamber 20 and in the number of the second inlet openings 2011. In addition to the one second inlet opening 2011a for the second fluid 8 (phase B), a further second inlet opening 2011b is provided in the mixing chamber 20. Said further second inlet opening 2011b can in principle also carry the second fluid 8 into the mixing chamber 20. Alternatively, the further second inlet opening 2011b can serve to carry a further phase C or a third fluid into the mixing chamber 20. In FIG. 7 there are two second inlet openings 2011. However, it is also possible for more than two second inlet openings to be provided.

The two second inlet openings 2011a, 2011b are formed in a common boundary wall of the inlet channel 206. In principle, the two or at least two second inlet openings 2011 can also be formed on mutually opposing sides of the mixing chamber 20. That is to say that at least one second inlet opening 2011 (as shown in FIG. 4) is formed on the upper side of the device 1, and at least one further second inlet opening 2011 is formed on the underside of the device 1 that is opposite the upper side.

In FIG. 7, the two second inlet openings 2011 are located side-by-side, and in this case are at the same spacing l₂₀₁₁ (along the longitudinal axis L) from the first inlet opening 201. Alternatively, the second inlet openings 2011 can have different spacings l₂₀₁₁.

It is advantageous if a spacing b₂₀₁₃ (transversely to the longitudinal axis L) between the second inlet openings 2011 is selected so as to be small. It is advantageous if the spacing b₂₀₁₃ between the two second inlet openings 2011a and 2011b is smaller than the width b₂₀₁ of the first inlet opening 201.

In the above embodiments, the devices each comprise an interaction channel 30 downstream of the outlet opening 202 of the mixing chamber 20. However, said interaction channel is merely optional. The device according to the solution can also do without such an interaction channel. In the above embodiments, the devices have a specific number of (at least one) first/second inlet openings, outlet openings and first/second supply devices. In fact, there could in each case also be more than just one.

It is advantageous if the boundary surfaces of the device 1, which come into contact with the first fluid 7, the second fluid 8 or the fluid mixture 9 have a low surface roughness. The risk of deposition of components of the fluids in the device 1 is already very low on account of the dynamically moving fluid jet. This effect can be increased by the low surface roughness, which increases the stability of the device in continuous operation. It is particularly advantageous if the surface, in particular in the mixing chamber, is lipophilic.

Different types of fluidic components can be used. These can comprise auxiliary flow channels or other means as means for specifically changing the direction. In the description, the terms height h and depth t are used synonymously for the extension transversely to the oscillation plane of the first fluid.

The device 1 according to the solution makes it possible for a large volume flow range for example between 20 ml/min and 200 ml/min for the first or second fluid 7 or 8, respectively, to be used. In the event of particles being produced in the mixing chamber 20, the particle size is not significantly changed by the volume flow. As a result, the device 1 is very robust with respect to possible fluctuations in the volume flow that may occur for technical reasons. Furthermore, this system can be used at the laboratory scale and for mass production.

FIG. 8 shows an embodiment, by way of example, of an interaction channel 30. The interaction channel 30 is an optional component of the device 1. If present, the interaction channel 30 is connected to the outlet opening 202 of the mixing chamber 20.

The interaction channel 30 is pipe-shaped and, in FIG. 8, has a plurality of bends 31.

The number of bends and the bend radius is merely by way of example in FIG. 8. In general, the shape of the interaction channel 30 is to be formed such that no wake spaces occur, in order to prevent uncontrolled agglomeration. When flowing through the interaction channel 30, the fluid mixture 9 emerging from the outlet opening 202 has a further opportunity for mixing. Should particles have been produced during the mixing process, in the mixing chamber 20, then the interaction channel can be used for growth of the particles. The dwell time of the produced fluid mixture 9 or the particles can be controlled by the length of the interaction channel 30.

FIG. 9 schematically shows the deflection of the moving (oscillating) first fluid 7 (at the outlet opening 102 of the fluidic component 10) over time. It can be seen that the first fluid oscillates periodically between two maximum deflections of, here, by way of example, approximately ±25°. In this case, the dashed line represents an idealized sinusoidal course of the moving fluid jet. In order to increase the mixing quality in the mixing chamber 20, an additional intermediate oscillation is advantageous. Such an intermediate oscillation is shown by the solid line and is provided at approximately ±5°.

A temporal course of this kind (comprising an intermediate oscillation) can be produced for example using the fluidic components 10 from FIG. 6 or 7. According to FIG. 9, the oscillation angle α is approximately 50°. In principle the oscillation angle can also deviate from this value. The oscillation angle is selected depending on the desired mixing quality the fluids to be mixed, and the volumes to be mixed.

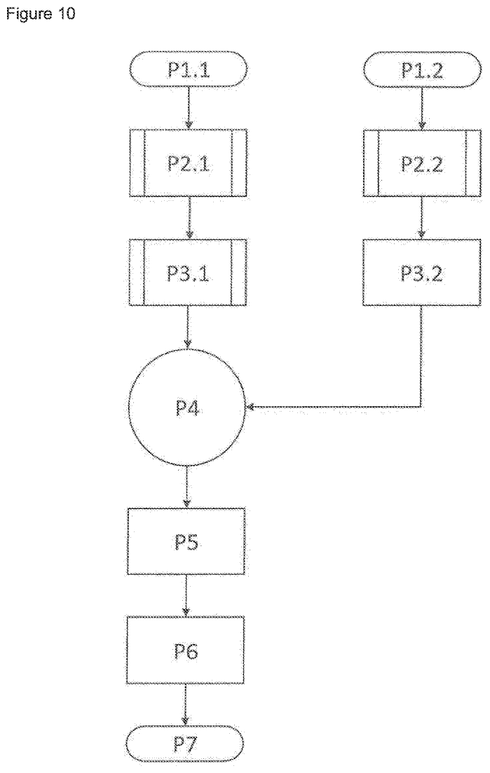

FIG. 10 schematically shows the sequence of a method according to the solution for mixing (here, by way of example, two) fluids and for producing a fluid mixture that comprises these two fluids. In order to carry out the method, a device according to the solution is used.

The first method steps, denoted P1.1, P2.1 and P3.1 in FIG. 10, relate to the first fluid 7 and are carried out in parallel with the method steps P1.2, P2.2 and P3.2, which relate to the second fluid 8. During these method steps, the first fluid 7 and the second fluid 8 are separate from one another.

Firstly, in the method steps P1.1 and P1.2, the volume flow of the first and second fluid, respectively, is set. As a result, the mixing ratio (and, in the event of particles being produced during the mixing process, optionally also the particle size) can be set.

In the following method steps P2.1 and P2.2, the intake pressure P_{10IN} of the first fluid 7 and the intake pressure P_{20IN} of the second fluid 8 are set by means of suitable pump devices (depending on the amount, for example syringe or transfer pumps), and the first and the second fluid 7, 8 are carried into the first or second supply device 40, 50, respectively. In this case, the intake pressure P_{10IN} of the first fluid 7 is the pressure at which the first fluid enters the flow chamber 100 of the fluidic component 10 (first supply device 40) via the inlet opening 101. In this case, the intake pressure P_{20IN} of the second fluid 8 is the pressure at which the second fluid enters the second supply device 50.

The applied intake pressures are in the range of a few millibars up to several hundred bar (relative to ambient pressure). For mass production, for example intake pressures of far above 2 bar are used. The pressure can assume three-digit values, such as 600 bar. A pressure range between 2 bar and 350 bar is preferred. A pressure range between 10 bar and 220 bar is particularly preferred.

After the first and second fluid 7, 8 have been introduced into the respective supply device 40, 50, their flow properties are adjusted by means of the supply devices 40, 50 in the method steps P3.1 and P3.2, respectively. For example, in P3.1 an oscillation of the first fluid 7 is produced by means of the fluidic component 10. The oscillation frequency is generally greater than 100 Hz. A movement frequency or oscillation frequency of several thousand hertz, such as 2000 Hz, is advantageous. Thus, a passively oscillating first fluid 7 is provided at the outlet opening 102 of the fluidic component 10. The oscillation angle of the first fluid can be at least 5°, preferably at least 25°, particularly preferably at least 40°. For many applications, an oscillation angle of between 25° and 50°, in particular between 30° and 45°, is suitable. A typical maximum value for the oscillation angle is 75°.

In the parallel method step P3.2, a (quasi) stationary second fluid jet 8 is produced in the second supply device 50, by means of the associated pump device. It is alternatively also possible for an oscillation of the second fluid 8 to be produced in the method step P3.2, by means of the second supply device 50. (For this purpose, the second supply device 50 is to be provided with a fluidic component 10 similar to that of the first supply device 40).

In method step P4, the oscillating first fluid jet 7, which is provided by the first supply device 40, and the (quasi) stationary second fluid jet 8, which is provided by the second supply device 50, are carried into the mixing chamber 20 via the first or second inlet opening 201, 2011, respectively, and combined there. The collision takes place at the angles β and η, which have already been explained in greater detail above, in connection with the device 1. When the method is applied at the industrial process scale or in mass production, the fluid 7 and/or fluid 8 are carried into the mixing chamber 20 at a continuous volume flow.

The method step P7 can directly follow the method step P4, in which method step P7 the produced fluid mixture 9 is removed from the device 1. The method step P7 can furthermore comprise thermal treatment (cooling) of the produced fluid mixture and/or the separation of a component (for example a solvent) from the fluid mixture. However, one or more intermediate steps P5 and/or P6 can be provided between P4 and P7.

Thus, in the method step P5 the fluid mixture 9, which emerges from the mixing chamber 20, via the outlet opening 202 thereof, at the end of the mixing process P4, can be carried into an interaction channel 30 that adjoins in the downstream direction, in which channel the fluid mixture 9 has a further opportunity for mixing. If particles have resulted during the mixing process P4, these particles can grow in the interaction channel 30. The interaction channel 30 has already been explained in greater detail above, in connection with the device 1.

The method step P6 can optionally follow the method step P5. Alternatively, the method step P7 can directly follow the method step P5. The method step P6 provides that the produced fluid mixture (with or without particles) is mixed with a further medium (fluid), for example for the purpose of dilution. The medium can be selected according to the nature of the produced fluid mixture. This can be beneficial for the further processing, for example if nanoparticles have been produced.

The described method can be used in chemistry for producing chemical mixtures. The described method can also be used in microbiology, biochemistry, pharmaceutics, medical technology, and food technology. In order to produce pharmaceutical or therapeutic microparticles, the method can be carried out using a solvent mixed with pharmaceutical or therapeutic material, and/or using a fluid mixed with one or more particle-containing pharmaceutical or therapeutic materials, as the first and/or the second fluid 8.

The method can thus be used for encasing RNA, of a defined particle size, in a lipid layer. In this case, the first fluid 7 can be an aqueous solution comprising RNA (for example mRNA), and the second fluid 8 can be a lipid or a lipid mixture.

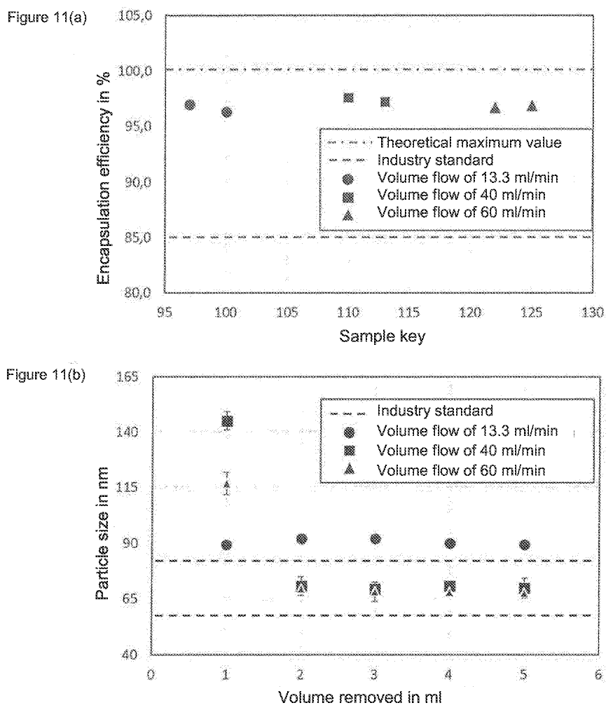

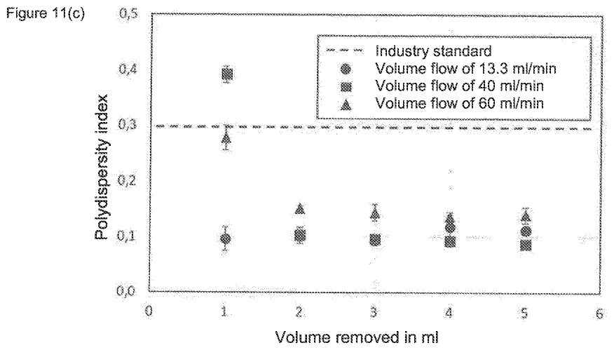

FIG. 11 shows measured values of a fluid mixture which has been produced using the device from FIG. 5 and the method from FIG. 10. The fluid mixture contains particles produced during the mixing process. Specifically, in this case an mRNA batch was used as the first fluid, and a lipid mixture as the second fluid. During the mixing process, mRNA particles were formed, which are enclosed by a lipid layer. The method was carried out multiple times using different volume flows (13.3 ml/min, 40 ml/min and 60 ml/min). In this case, the volume flow of the first fluid is in each case three times the size of the volume flow of the second fluid. The volume flows specified in FIG. 11 correspond in each to the sum of the first and second fluid. The volume flow is dependent for example on the composition of the lipid mixture.

FIG. 11 shows, in three graphs a), b) and c), measured values relating to the characteristic variables of encapsulation efficiency (graph a)), particle size (graph b)), and polydispersity index, abbreviated PDI (graph c)), in each case for three different volume flows. The encapsulation efficiency specifies the percentage portion of the mRNA which is present in particle form. The polydispersity index specifies the size distribution of the mRNA particles. In this case, a polydispersity index of 0 means that all the particles are the same size. In all the graphs, the values on the x-axis merely represent different samples taken at different points in time.

It can be seen from graph a) that the encapsulation efficiency is always between 95% and 100%, irrespective of the volume flow set. (This efficiency also occurs in the case of volume flows which are above or below the values given in FIG. 11.) In the case of industrial preparation of mRNA particles, which are encased by a lipid layer, a value above 85% is expected as standard. The method according to the solution can meet this standard without problem.

Regarding the particle size (graph b)), it is clear that, in the case of a small volume flow of, here, 13.3 ml/min, a particle size of approximately 90 nm is achieved, and that the particle size reduces to approximately 70 nm by increasing the volume flow to 40 ml/min. In contrast, a further increase of the volume flow to 60 ml/min does not result in any further reduction in the particle size. The selection of the suitable volume flow makes it possible for mRNA particles, surrounded by a lipid layer, to be produced by means of the method according to the solution, the size of which particles is in the standard size range (dashed line). In this case, the size of the volume flow can be influenced by the composition of the lipid mixture.

The size distribution of the produced particles (graph c)) is relatively narrow, wherein the size of the volume flow has only a negligibly small effect on the size distribution of the particles. Graph c) shows that the method according to the solution is within the scope of the industry standard also with regard to the size distribution of the mRNA particles surrounded by a lipid layer.

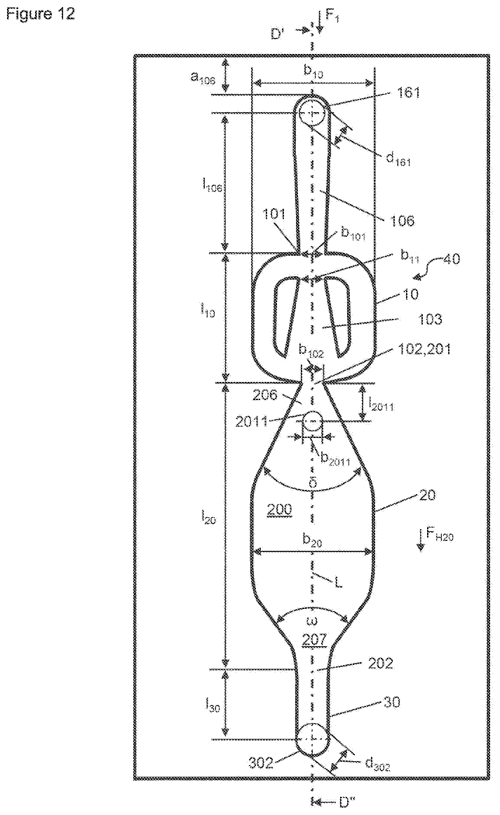

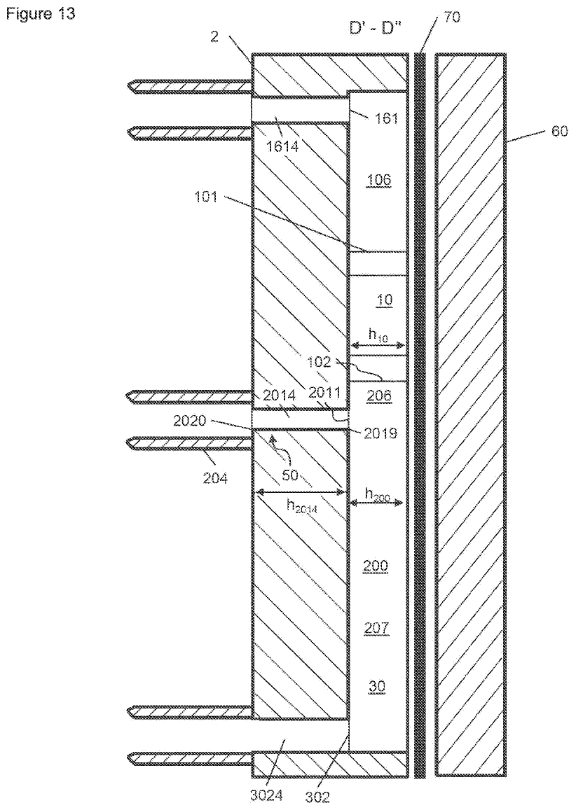

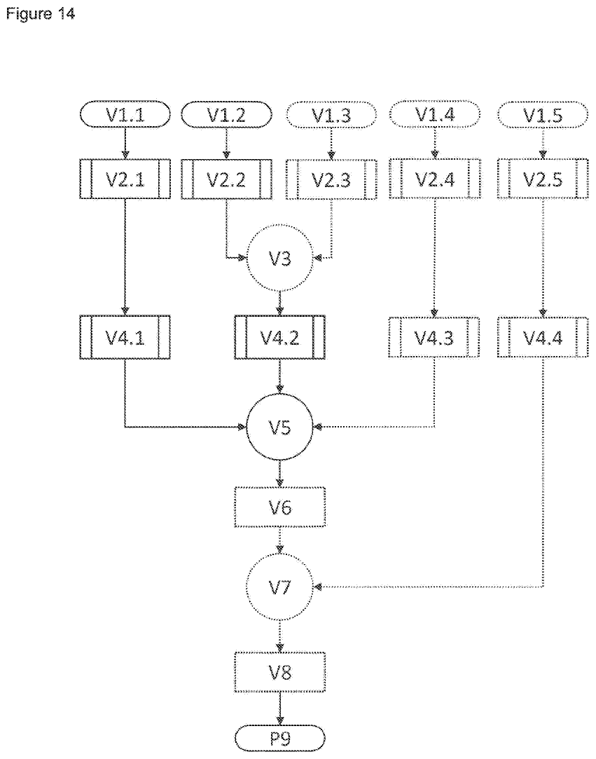

A further embodiment of the device 1 is shown in FIGS. 12 and 13. Just like the device from FIG. 1 to 4, the device 1 comprises a first supply device 40 and a second supply device 50, which each lead into a mixing chamber 20, as well as an interaction channel 30 which adjoins the outlet opening 202 of the mixing chamber 20.

In this case, the first supply device 40 comprises a fluidic component 10 as a means for a targeted dynamic change in direction of the first fluid 7, such that the fluid flow of the first fluid 7 moves within the mixing chamber 20, while having a movement component along the first fluid flow direction F₁ and a movement component transversely to the first fluid flow direction F₁. In this case, the first fluid flow direction F₁ corresponds to a main flow direction F_{H20} within the mixing chamber 20. In this case, the movement of the first fluid 7 can be variable over time. The main flow direction F_{H20} within the mixing chamber 20 is directed from the first inlet opening 201 of the mixing chamber 20 towards the outlet opening 202 of the mixing chamber 20. A periodic movement, variable over time, of the fluid flow of the first fluid 7, in the mixing chamber 20, is also conceivable, which movement can be interpreted as an oscillation, vibration, rotation or pulsation of the fluid flow. The supply device 40 from FIG. 12 can comprise, as a fluidic component 10, the fluidic component 10 from the device 1 according to FIG. 1. The fluidic component 10 (and its constituents) from FIG. 12 can accordingly be of the dimensions (length, width, height, depth, diameter) that have been described above for the fluidic component 10 (and its constituents) from FIG. 1.

The embodiment from FIG. 12 differs from that of FIG. 1 in particular in the design upstream of the inlet opening 101 of the fluidic component 10 (part of the first supply device 40) and downstream of the outlet opening 202 of the mixing chamber 20. While in the embodiment of FIG. 1 the funnel-shaped attachment 106 is provided upstream of the inlet opening 101, and extends exclusively within the oscillation plane in which the first fluid 7 moves in the fluidic component 10, such that the first fluid 7 flows exclusively along the first fluid flow direction F₁, within the oscillation plane, before reaching the inlet opening 101, in the embodiment from FIG. 12 an inlet channel 1614 is provided upstream of the attachment 106. The inlet channel 1614 extends substantially perpendicularly to the oscillation plane and thus perpendicularly to the attachment 106.

In this case, the attachment 106 directly adjoins the inlet channel 1614. The transition between the inlet channel 1614 (or its downstream end) and the attachment 106 (or its upstream end) is denoted by the reference sign 161 in FIG. 13. The attachment 106 and the inlet channel 1614 can be formed in one piece. In particular, the inlet channel 1614 can be formed in a boundary wall which extends in parallel with the oscillation plane and delimits the attachment 106, wherein the inlet channel 1614 completely penetrates the boundary wall transversely to the oscillation plane. The first fluid 7, which flows through the inlet channel 1614 and the attachment 106, thus undergoes a deflection about substantially 90°.

Similar occurs in the embodiment of FIG. 12, downstream of the outlet opening 202 of the mixing chamber 20. An outlet channel 3024 directly adjoins the interaction channel 30, in the downstream direction. The transition between the interaction channel 30 (or its downstream end) and the outlet channel 3024 (or its upstream end) is denoted by the reference sign 302 in FIG. 13. In this case, the interaction channel 30 extends exclusively in the oscillation plane, and the outlet channel 3024 extends substantially perpendicularly to the oscillation plane. The interaction channel 30 and the outlet channel 3024 can be formed in one piece. In particular, the outlet channel 3024 can be formed in a boundary wall which extends in parallel with the oscillation plane and delimits the interaction channel 30, wherein the inlet channel 1614 completely penetrates the boundary wall transversely to the oscillation plane. The produced fluid mixture 9, which flows through the interaction channel 30 and the outlet channel 3024, thus undergoes a deflection about substantially 90°.

The inlet channel 1614 and the outlet channel 3024 each have a constant diameter and are, by way of example, cylindrical. In this case, the inlet channel 1614 has a diameter d₁₆₁ of 0.45 mm, and the outlet channel 3024 has a diameter d₃₀₂ of 0.5 mm. Alternatively, these two diameters can also be the same size. In an advantageous embodiment, the diameter d₃₀₂ is no smaller than the largest value of b₂₀₁₁ (width of the second inlet opening 2011), and d₁₆₁: d₃₀₂≥max(b₂₀₁₁, d₁₆₁). The suitable size ratio of d₁₆₁ and d₃₀₂ is dependent on the nature of the fluids to be mixed, the interaction (for example collision) thereof, or chemical reactions with one another, as well as the quantity ratio of the fluids to be mixed.

According to an advantageous embodiment, no step is formed at the transition 161 between the inlet channel 1614 and the attachment 106, or at the transition 302 between the interaction channel 30 and the outlet channel 3024. In this case, the wall of the inlet channel 1614 (interaction channel 30) transitions directly and in a stepless manner into the wall of the attachment 106 (outlet channel 3024). However, a step can also be formed at the mentioned transitions 161, 302. Thus, in FIG. 12, by way of example, a step is shown at the transition 161 between the inlet channel 1614 and the attachment 106, wherein the diameter d₁₆₁ of the inlet channel 1614 is smaller than the width b₁₀₆ (extension in the oscillation plane and transversely to the longitudinal axis L) of the attachment 106. In contrast, in FIG. 12 the diameter d₃₀₂ of the outlet channel 3024 and the width b₃₀₀ (extension in the oscillation plane and transversely to the longitudinal axis L) of the interaction channel 30 are of the same size.

The inlet channel 1614 is fluidically connected to the inlet opening 101 of the fluidic component 10, via the attachment 106. According to an advantageous embodiment, the length l₁₀₆ (extension along the longitudinal axis L from the center point of the diameter d₁₆₁ of the inlet channel 1614 to the inlet opening 101) of the attachment 106 corresponds at least to the sum of twice the width b₁₀₁ and twice the diameter d₁₆₁: l₁₀₆≥2×b₁₀₁+2× d₁₆₁.

In the embodiment of FIG. 12, the width b₁₀₁ of the inlet opening 101 and the width b₁₁ of the smallest cross-sectional area A₁₁ in the main flow channel 103 between the inner blocks 11a, 11b are of the same size, and each have the value 0.38 mm.

The outlet opening 202 of the mixing chamber 20 is fluidically connected to the outlet channel 3024 via the interaction channel 30. The interaction channel 30 has a constant width b₃₀₀ (extension in the oscillation plane and transversely to the fluid flow direction), at least in portions. In the embodiment from FIG. 12, the width b₃₀₀ is constant over the entire length of the interaction channel 30 and is approximately 0.5 mm. The length l₃₀ of the interaction channel 30 is defined along the longitudinal axis L (or fluid flow direction) between the outlet opening 202 of the mixing chamber 20 and the center point of the diameter d₃₀₂ of the outlet channel 3024, and can assume different values. The length l₃₀ is preferably twice the size of the diameter d₃₀₂: l₃₀≥2×d₃₀₂. When using the device for producing lipid nanoparticles, l₃₀≥5×d₃₀₂ is advantageous. If the interaction channel 30 is not straight, such as in the embodiment from FIG. 8, then the length l₃₀ is defined along the center line of the interaction channel 30.

In the embodiment of FIG. 12, the second inlet opening 2011 of the mixing chamber 20 has a circular cross section. Here, the width b₂₀₁₁ (extension in the oscillation plane and transversely to the longitudinal axis L) is, by way of example, 0.3 mm, such that the second inlet opening 2011 has a cross-sectional area of approximately 0.07 mm². Along the longitudinal axis L, the spacing between the first inlet opening 201 of the mixing chamber 20 and the center point of the second inlet opening 2011 of the mixing chamber 20 is 1.01 mm. The component depth h₂₀₆ (extension transversely to the oscillation plane) of the mixing chamber 20 in the region between the first and the second inlet opening 201, 2011 is advantageously no greater than three times the width b₂₀₁₁: h₂₀₆≤3×b₂₀₁₁. It is particularly preferable if h₂₀₆≤2.75×b₂₀₁₁.

At the height of the center point of the second inlet opening 2011, the mixing chamber 20 has a cross-sectional area A_{20,b2011m} (transversely to the longitudinal axis L) of approximately 0.25 mm². Further upstream (with respect to the first fluid flow direction F₁) in the mixing chamber 20, at the height directly before the second inlet opening 2011, the cross-sectional area A_{20,b2011a} (transversely to the longitudinal axis L) of the mixing chamber 20 is approximately 0.21 mm². Further downstream (with respect to the first fluid flow direction F₁) in the mixing chamber 20, at the height directly after the second inlet opening 2011, the cross-sectional area A_{20,b2011e} (transversely to the longitudinal axis L) of the mixing chamber 20 is approximately 0.3 mm². The depth of the mixing chamber 20 is the same in these three regions. The cross-sectional areas A_{20,b2011a} and A_{20,b2011e} can also be the same size, or A_{20,b2011a} can be greater than A_{20,b2011e}. A_{20,b2011m} can assume any values between the values A_{20,b2011a} and A_{20,b2011e}.

The specific size ratio can depend on the desired application. According to an advantageous embodiment, the cross-sectional area A_{20,b2011e} of the mixing chamber 20 is at least the same size as the sum of the cross-sectional areas A₂₀₁, A₂₀₁₁ of the first and second inlet opening 201, 2011 of the mixing chamber 20: A_{20,b2011e}≥A₂₀₁+A₂₀₁₁. In addition to the condition A_{20,b2011e}≥A₂₀₁+A₂₀₁₁, the condition A_{20,b2011e}≥3.5×A₂₀₁ can apply. If both conditions are met and the component depth h₂₀₆ (extension transversely to the oscillation plane) in the region of the inlet channel 206 of the mixing chamber 20 is constant, then the mixing of the first fluid 7 with the second fluid 8 can be optimized.

In the embodiment of FIG. 12, the fluidic component 10 has a volume V₁₀ of approximately 0.67 mm³. The volume V₁₀ is defined as the space through which the first fluid 7 can flow between the inlet opening 101 of the fluidic component 10 and the outlet opening 102 of the fluidic component 10. In this case, the main flow channel 103 of the fluidic component 10 has a volume V₁₀₃ of approximately 0.32 mm³. The volume V₂₀ of the mixing chamber 20 is approximately 1.68 mm³. The volume V₂₀ is defined as the space through which the first fluid 7, the second fluid 8 or the produced fluid mixture 9 can flow between the first and the second inlet opening 201, 2011 of the mixing chamber 20, and the outlet opening 202 of the mixing chamber 20. The inlet opening 201, 2011 and the outlet opening 202 are in each case defined where the cross-sectional area (transversely to the fluid flow direction) of the mixing chamber 20, through which the fluid flow passes when it enters the mixing chamber 20 or emerges from the mixing chamber 20 again, is smallest in each case. The volume V₂₀ in particular does not include the space upstream of said smallest cross-sectional area, in which only one of the fluids 7, 8 of the mixing chamber 20 is supplied. The volume V₂₀ in particular also does not include the space downstream of said smallest cross-sectional area, in which the fluid mixture 9 is discharged. Furthermore, the volume V₄₀ of the complete first supply device 40 is approximately 1.017 mm³. In this case, the volume V₄₀ is defined as the space through which the first fluid 7 can flow between the upstream end of the inlet channel 1614 and the outlet opening 102 of the fluidic component 10. It is advantageous for the mixing result if the volume V₂₀ of the mixing chamber 20 is greater than the volume V₄₀ of the supply device 40: V₂₀>V₄₀, or V₂₀>V₄₀>V₁₀>V₁₀₃. The above specific volume details relate to a variant of the device 1 from FIG. 12. Depending on the desired application, the device 1 can be scaled, wherein the ratio of the volumes, which are specified for the variant, is maintained.

FIG. 13 is a sectional view of the device 1 from FIG. 12 along the line D′-D″. A cover element 60 and an optional seal 70 are also shown, which in each case extend in a plane in parallel with the oscillation plane and are arranged on the side of the device 1 which faces away from the second inlet opening 2011. The cover element 60 is shown here only in cross section, but extends over the entire device 1. For the sake of clarity, spacings are shown between the cover element 60, the seal 70, and the body 2 of the device 1, in which the fluid-conducting functional elements 40, 50, 20, 30 are formed, which spacings, however, are not actually present.

The cover element 60 seals the fluid-conducting functional elements 40, 20, 30 relative to the surroundings. In the embodiment shown, the inlet channel 1614 upstream of the inlet opening 101 of the fluidic component 10, the supply channel 2014 leading into the second inlet opening 2011 of the mixing chamber 20, and the outlet channel 3024 of the interaction channel 30 are formed as drilled holes in the body 2, perpendicularly to the oscillation plane. In principle, however, these drilled holes can alternatively or additionally be formed in the cover element 60.

In the embodiment of FIG. 1 to 4, the body 2 and the cover element 60 are formed in one piece, wherein the fluid-conducting functional elements are incorporated in a material block. This design is in principle also possible for the embodiment of FIGS. 12 and 13. Likewise, the design (body 2, cover element 60 and seal 70, separately) can be applied to the embodiment of FIG. 1 to 4.

The seal 70 can be produced from a resilient material. In particular in applications of the device 1 in which an intake pressure P_{10IN} of over 5 bar is applied at the first supply device 40 (specifically at the inlet channel 1614), the use of a resilient material is advantageous. The embodiment of the device 1 shown in FIGS. 12 and 13 can be operated for example having an intake pressure P_{10IN} at the inlet channel 1614 of 0.5 bar to 90 bar (first fluid 7), and having an intake pressure P_{20IN} at the supply channel 2014 of 0.5 bar to 90 bar (second fluid 8). Typical intake pressures are in the range between 0.75 bar and 65 bar. If the device 1 from FIGS. 12 and 13 is used in a method for producing lipid nanoparticles, then in this method intake pressures P_{10IN}, P_{20IN} between 1 bar and 30 bar can be applied. Typical intake pressures are in the range between 2 bar and 6 bar.

A supply channel 2014 is formed directly upstream (with respect to the second fluid flow direction F₂) of the second inlet opening 2011 of the mixing chamber 20. The supply channel 2014 is formed as a cylindrical drilled hole and has a diameter d₂₀₁₄ which corresponds to the width b₂₀₁₁ of the second inlet opening 2011. However, the diameter d₂₀₁₄ can also be different from the width b₂₀₁₁. In the embodiment of FIGS. 12 and 13, the second inlet opening 2011 comprises a sharp edge. In principle, this can also be configured differently, for example having a chamfer or a radius. It is particularly advantageous, however, to design the second inlet opening 2011 so as to be sharp-edged and burr-free. The supply channel 2014 can be fluidically connected to a pipe piece 204 or a tube (FIG. 13). In this case, the diameter of the pipe piece 204 or of the tube is greater than that of the supply channel 2013. This results in a step 2020, which is configured having sharp edges in FIG. 13, in the transition region. However, the transition between the pipe piece 204 or tube and the supply channel 2014 can also be configured to be flowing (stepless) or a chamfer can be formed at the step 2020. As already mentioned in conjunction with the embodiment of FIG. 1 to 4, the supply channel 2014 (or the pipe piece 204 connected thereto) encloses an angle β and an angle η with the oscillation plane. In this case, the angle β is measured in a plane that extends in parallel with the longitudinal axis L and perpendicularly to the oscillation plane. In contrast, the angle η is measured in a plane that extends perpendicularly to the longitudinal axis L and perpendicularly to the oscillation plane. The size specifications for the angles β and η in the embodiment of FIG. 1 to 4 also apply for the embodiment of FIGS. 12 and 13.

The above-mentioned geometric relations for the device 1 end with the supply channel 1614 and the supply channel 2014, and with the outlet channel 3024, and in particular do not include fluid supply means which are to be connected to the supply channel 1614 and to the supply channel 2014, and devices for collecting the fluid mixture output by the outlet channel 3024.

The supply channel 2014 has a length h₂₀₁₄ which is denoted in FIG. 13. The length h₂₀₁₄ is at least 2.5 times the width b₂₀₁₁: h₂₀₁₄≥2.5×b₂₀₁₁. Particularly preferably the following applies: h₂₀₁₄≥4.2×b₂₀₁₁.

In the embodiment of FIGS. 12 and 13, the fluidic component 10 and the mixing chamber 20 are of the same height (extension transversely to the oscillation plane): h₁₀=h₂₀. The heights h₁₀ and h₂₀ are constant over the entire extension of the fluidic component 10 or the mixing chamber 20, and are 0.3 mm. Thus, the height h₁₀₂ at the outlet opening 102 of the fluidic component 10 is also 0.3 mm. As a result, the dimensions b₁₀₂ and h₁₀₂ assume the same value of 0.3 mm and thus form A_{1 min}. The terms height h and depth h in each case denote the extension transversely to the oscillation plane, and are therefore used synonymously in this application.

In the case of the above-mentioned geometric specifications, the produced fluid mixture 9 can have an overall volume V₉ of 10 ml/min to 90 ml/min (measurable in the outlet channel 3024). In the overall volume flow V₉, the first fluid 7 can have a volume fraction of 75%, and the second fluid 8 can have a volume fraction of 25%. An overall volume flow V₉ of 10 ml/min to 90 ml/min thus results at intake pressures P_{10IN} and P_{20IN} at the inlet channel 161 or at the supply channel 2013 of 2 bar to 6 bar, and vice versa.

The device 1 according to the solution makes it possible to adjust the volume flow of the first fluid 7, the volume flow of the second fluid 8, the overall volume flow V₉ of the fluid mixture, and the intake pressures P_{10IN}, P_{20IN} over a large process range, without changing the quality of the produced fluid mixture 9 or of the produced particles significantly. Furthermore, the device 1 is relatively insensitive to pressure pulsations of the first and second fluid, such that the method that uses the device 1 for producing a fluid mixture is also relatively insensitive to the mentioned pressure pulsations. Pressure pulsations are produced for example by pressure-increasing means, which are used for example in the method from FIG. 10 (FIG. 15) in method steps P2.1 and P2.2 (V2.1 and V2.2 and optionally V2.3 to V2.5).

The volume flows of the first and of the second fluid can be changed, at constant intake pressures P_{10IN}, P_{20IN}, by changing the width b₁₀₂ and/or the height h₁₀₂ of the outlet opening 102 of the fluidic component 10. In the embodiment of FIGS. 12 and 13, the length ratio E₁₀₂, which is defined by E₁₀₂=b₁₀₂/h₁₀₂, is equal to 1. However, E₁₀₂ can also be different from 1.

Various embodiments of the device 1 are described above, wherein for individual embodiments specific geometric dimensions (length, width, height, depth, diameter) are specified. These relate to a specific variant of the respective embodiment of the device 1. Depending on the desired application, the device 1 can be scaled, wherein the essential size ratios of the geometric dimensions, which are specified for the specific variant, are maintained. Depending on the mixing task, individual geometric dimensions can be adjusted accordingly.

FIG. 15 schematically shows the sequence of a method according to the solution for mixing at least two fluids and for producing a fluid mixture 9 that comprises the at least two fluids. For the method from FIG. 15 (as also for the method from FIG. 10), the device 1 in the embodiment of FIGS. 12 and 13 can be used. However, the device 1 according to one of the other embodiments (FIG. 1 to 8) can also be used. The intake substances used for the method can be present absolutely in gaseous form or solid form at room temperature. By means of temperature control and/or adjustment of the intake pressure before and/or in the device 1, the intake substances can then be converted into the desired fluid form, such that they are preferably present in liquid form for the mixing process in the mixing chamber 20 and also in the fluidic component 10.

Method steps that are denoted in FIG. 15 in boxes having a dotted edge are merely optional.

The first method steps V1.1 and V1.2, and optionally V1.3, V1.4 and V1.5, are carried out in parallel. In this case, the first fluid 7 and the second fluid 8 (or components thereof), and three further fluids (if used), are provided separately. In these method steps, the volume flow of the fluids used (and the volume flow ratios) are adjusted. As a result, the mixing ratio (and, in the event of particles being produced during the mixing process, optionally also the particle size) can be set. In particular, changing the volume flow ratios of the fluids used makes it possible to adjust the size of the particles produced, without significantly changing the monodispersity of the particle size distribution (i.e. polydispersity index close to 0) achieved using the device 1 according to the solution. For example, the mixing ratio of 75% volume fraction for the first fluid 7 in step V1.1 and 25% volume fraction for the second fluid 8 in step V1.2 can be set for producing mRNA nanoparticles. In this case, the first fluid 7 can be an aqueous mRNA solution, and the second fluid 8 can be a lipid mixture. In order to produce the mRNA nanoparticles, the overall volume flow V₉ can be 10 ml/min, wherein for the first fluid 7 a constant volume flow V₇ of 7.5 ml/min, and for the second fluid 8 a constant volume flow V₈ of 2.5 ml/min, is set. The three further fluids can include, for example, an organic solvent, the volume flow of which is adjusted in method step V1.4. It can be provided for the organic solvent to be removed again in a later method step.

In the second method steps V2.1 and V2.2, and optionally V2.3, V2.4 and V2.5, the intake pressure P_{10IN} of the first fluid 7 (or components thereof) and the intake pressure P_{20IN} of the second fluid 8 (or components thereof) are set by means of suitable pump devices (depending on the amount, for example syringe or transfer pumps). In this case, the intake pressure P_{10IN} of the first fluid 7 is the pressure at which the first fluid enters the flow chamber 100 of the fluidic component 10 (first supply device 40) via the inlet opening 101. In this case, the intake pressure P_{20IN} of the second fluid 8 is the pressure at which the second fluid enters the second supply device 50.

In the second method steps V2.1 and V2.2, and optionally V2.3, V2.4 and V2.5, the intake substances used can, if required, be temperature-controlled. The intake pressure can also be adjusted, in order to provide the intake substances with the necessary physical properties. Thus, for example, the viscosity of the intake substances can be adjusted. Depending on the type of the intake substances, temperature and/or intake pressure can influence the mixing ratio or the result of the mixing process.

The third method step V3 is optional. In this step, the first fluid 7 or the second fluid 8 can be produced by mixing the fluids treated in V1.2 and V1.3, and in V2.2 and V 2.3, provides these are not already the first or second fluid, respectively. The device according to the solution can be used for method step V3. However, in principle other devices for mixing can also be used for method step V3.

In the fourth method steps V4.1 and V4.2, and optionally V4.3 and V4.4, the first and the second fluid 7, 8, and optionally further fluids, are carried into the first or second supply device 40, 50, respectively. By means of the supply devices 40, 50, the flow properties are adjusted in method steps V4.1 ad V4.2, and optionally V4.3 and V4.4.

Thus, in V4.1 an oscillation of the first fluid 7 is produced by means of the fluidic component 10. The oscillation frequency is generally greater than 100 Hz. A movement frequency or oscillation frequency of several thousand hertz, such as 2000 Hz, is advantageous. Thus, a passively oscillating first fluid 7 is provided at the outlet opening 102 of the fluidic component 10. The oscillation angle of the first fluid can be at least 5°, preferably at least 25°, particularly preferably at least 40°. For many applications, an oscillation angle of between 25° and 50°, in particular between 30° and 45°, is suitable. A typical maximum value for the oscillation angle is 75°. The use of a first supply device 40 (in particular a fluidic component 10) according to FIGS. 1 to 7 and 12 and 13 has the advantage that undesired pressure fluctuations, which can occur in the second method steps, can be damped, such that the method is relatively insensitive to such pressure fluctuations.

In the parallel method step V4.2, a (quasi) stationary second fluid jet 8 is produced and accelerated in the second supply device 50, by means of the associated pump device.

Depending on the specific task or the desired mixing quality, a reduction in the speed of the second fluid 8 may be advantageous. It is alternatively also possible for an oscillation of the second fluid 8 to be produced in the method step V4.2, by means of the second supply device 50. (For this purpose, the second supply device 50 is to be provided with a fluidic component 10 similar to that of the first supply device 40).

The method steps V5 comprises the combining and interaction of the first and second fluid in the mixing chamber 20, and corresponds to the method step P4 from FIG. 10. In the method step V5, the components of the fluid mixture 9 interact with one another, which leads for example to precipitation reactions or particle growth (if particles have resulted during the mixing process V5). Optionally, at least one further fluid, e.g. from V4.3, can be combined with the first and second fluid, for example in order to bring about a chemical reaction. In this case, the method can be carried out using the device 1 from FIG. 7. The method step V9 can take place directly after this method step V5, in which method step V9 the produced fluid mixture 9 is removed from the device 1.

One or more intermediate steps V6, V7 and/or V8 can be provided between the method steps V5 and V9.

In the optional method step V6, the components of the fluid mixture 9 can interact with one another beyond V5. The method step V6 takes place in the interaction channel 30 (provided specifically for this method step), which adjoins the mixing chamber 20 in the downstream direction. In the interaction channel 30, the mixing can be improved and/or the size of the produced particles can be adjusted.

The method step V7 can optionally follow the method step V5 or V6. Said method step provides that the produced fluid mixture 9 (with or without particles) is mixed with a further medium (fluid), e.g. from V4.4, for example for the purpose of dilution. The medium can be selected according to the nature of the produced fluid mixture. This can be beneficial for the further processing, for example if nanoparticles have been produced.

The method step V8 can optionally follow the method step V5, V6 or V7, in which method step V8 the produced fluid mixture is post-processed. The post-processing can be for example counting the number of particles produced, measuring the size of the particles produced, or checking the quality of the particles produced in the fluid mixture 9. Dialysis (treatment) and/or a filter process are also conceivable.

The final method step is V9, in which the produced fluid mixture 9 is removed from the device 1.

1. A device for mixing fluids and for producing a fluid mixture, comprising
a mixing chamber having a first inlet opening via which a first fluid can be introduced into the mixing chamber, a second inlet opening via which a second fluid can be introduced into the mixing chamber, and an outlet opening via which the fluid mixture comprising the first fluid and the second fluid can be discharged,
a first supply device, which is fluidically connected to the mixing chamber via the first inlet opening and is configured to carry the first fluid along a first fluid flow direction into the mixing chamber, and
a second supply device, which is fluidically connected to the mixing chamber via the second inlet opening and is configured to carry the second fluid along a second fluid flow direction into the mixing chamber,
wherein the first supply device comprises a fluidic component, comprising
an outlet opening, which is fluidically connected to the first inlet opening of the mixing chamber, and
at least one means for specifically changing the direction of the first fluid that flows through the fluidic component, in particular in order to cause an oscillation in space of said fluid at the outlet opening.

2. The device according to claim 1, wherein the fluidic component comprises a flow chamber through which the first fluid can flow and which comprises a main flow channel, which interconnects an inlet opening of the fluidic component and the outlet opening thereof, and at least one auxiliary flow channel as the means for specifically changing the direction of the first fluid.

3. The device according to claim 1, wherein the first supply device and the first inlet opening of the mixing chamber on the one hand, and the second supply device and the second inlet opening of the mixing chamber on the other hand, are arranged relative to one another in such a way that the first fluid flow direction and the second fluid flow direction enclose an angle of 0° to 90°, preferably of 35° to 55°, particularly preferably of 45°.

4. The device according to claim 1, wherein the means for specifically changing the direction of the first fluid is configured to bring about an oscillation of the first fluid in an oscillation plane, and in that the second supply device and the second inlet opening of the mixing chamber are arranged in such a way that the second fluid flow direction and the oscillation plane of the first fluid enclose an angle, in a plane transverse to the first fluid flow direction, of 30° to 150°, preferably 90°.

5. The device according to claim 1, wherein the mixing chamber has a longitudinal axis which extends along the first fluid flow direction, and in that the cross-sectional area of the mixing chamber, which is defined transversely to the longitudinal axis, changes along the longitudinal axis.

6. The device according to claim 5, wherein the cross-sectional area increases, proceeding from the first inlet opening of the mixing chamber in an upstream end portion of the mixing chamber forming an inlet channel, with increasing distance from the first inlet opening, and/or wherein the cross-sectional area reduces in a downstream end portion of the mixing chamber forming an outlet channel, with increasing distance from the first inlet opening.

7. The device according to claim 6, wherein the means for specifically changing the direction of the first fluid is configured to bring about an oscillation of the first fluid in an oscillation plane, and in that the extension of the mixing chamber in the oscillation plane and transversely to the longitudinal axis, proceeding from the first inlet opening of the mixing chamber, in the inlet channel, increases with increasing distance from the first inlet opening, or in that the extension of the mixing chamber in the oscillation plane and transversely to the longitudinal axis in the outlet channel decreases with increasing distance from the first inlet opening.

8. The device according to claim 6, wherein the second inlet opening of the mixing chamber is offset, relative to the first inlet opening of the mixing chamber, along the longitudinal axis of the mixing chamber, and is provided inside the inlet channel.

9. The device according to claim 8, wherein the distance between the first and the second inlet opening along the longitudinal axis corresponds to at least half the width of the first inlet opening of the mixing chamber, wherein the width is defined in parallel with the oscillation plane and transversely to the longitudinal axis.

10. The device according to claim 1, wherein the mixing chamber is of a volume that is greater than the volume of the fluidic component or of the flow chamber of the fluidic component.

11. The device according to claim 1, wherein the second supply device is provided and configured to carry the second fluid as a (quasi) stationary flow into the mixing chamber, or in that the second supply device comprises a fluidic component, comprising
an outlet opening, which is fluidically connected to the second inlet opening of the mixing chamber, and
at least one means for specifically changing the direction of the second fluid that flows through the fluidic component, in particular in order to cause an oscillation in space of said fluid at the outlet opening.

12. The device according to claim 1, wherein a second mixing chamber adjoins the outlet opening of the mixing chamber, in the downstream direction, wherein the second mixing chamber comprises a first inlet opening, a second inlet opening, and an outlet opening, wherein the first inlet opening of the second mixing chamber corresponds to the outlet opening of the upstream mixing chamber.

13. The device according to claim 1, wherein an interaction channel adjoins the outlet opening of the mixing chamber or of the second mixing chamber, respectively, in the downstream direction, which interaction channel has at least one bend.

14. A method for mixing fluids and for producing a fluid mixture, comprising the following steps:
providing a device according to claim 1, a first fluid, and a second fluid,
introducing the first fluid, at a first volume flow, into the mixing chamber via the first supply device, and simultaneously introducing the second fluid, at a second volume flow, into the mixing chamber via the second supply device, and discharging the fluid mixture, comprising the first fluid and the second fluid, out of the mixing chamber via the outlet opening thereof.

15. The method according to claim 14, wherein the first volume flow is greater than the second volume flow, or the first volume flow and the second volume flow are of the same size.

16. The method according to claim 14, wherein the first fluid and the second fluid is in each case a liquid or a suspension comprising a liquid and particles distributed therein.

17. The method according to claim 14, wherein the introduction of the first fluid into the mixing chamber, and the introduction of the second fluid into the mixing chamber, take place continuously in each case.

18. The method according to claim 14, wherein the first fluid and the second fluid differ with respect to the chemical composition and/or concentration of individual components.

19. The method according to claim 14, wherein the first fluid comprises RNA, in particular mRNA, and in that the second fluid comprises a lipid mixture.

20. The device according to claim 1, wherein the first supply device is configured to bring about the specific change in direction of the first fluid in such a way that the first fluid moves in a temporally variable manner within the mixing chamber, wherein the first fluid comprises a movement component along the first fluid flow direction and a movement component transversely to the first fluid flow direction and, wherein the first fluid moves, in particular periodically, in a temporally variable manner, within the mixing chamber.
